(19) United States
(12) Patent Application Publication
(10) Pub. No.: US 2005/0148321 A1
(43) Pub. Date: Jul. 7, 2005

(54) Network access control system

(76) Inventors: Yoichiro Igarashi, Kawasaki (JP); Masaaki Takase, Kawasaki (JP)

Correspondence Address: KATTEN MUCHIN ROSENMAN LLP, 575 MADISON AVENUE, NEW YORK, NY, 10022-2585, US

(21) Appl. No.: 11/075,104

(22) Filed: Mar. 7, 2005

Related U.S. Application Data
(63) Continuation of application No. PCT/JP03/11435, filed on Sep. 8, 2003.

(30) Foreign Application Priority Data
Nov. 13, 2002 (JP) 2002-329820

(51) Int. Cl. H04M 1/66

(52) U.S. Cl. 455/411; 455/422.1

(57) ABSTRACT

A network access control system comprises a reception unit receiving an authentication request message containing an authentication request of use of a secondary access network, the authentication request message is sent from a terminal that can use a core network by using a plurality of different types of access networks including a primary access network and the secondary access network, and arriving at the core network via the primary access network; an authentication unit performing authentication processing in response to the authentication request of the use of the secondary access network; and a transmission unit transmitting an authentication response message about the secondary access network that arrives at the terminal via the primary access network.

### BACKGROUND OF THE INVENTION

The present invention relates to a network access control system performing access control to a network about a terminal capable of performing communication that uses a core network by using multiple types of access networks.

With the rapid expansion of the Internet, the volume of IP (Internet Protocol) packet traffic is sharply increasing. In addition, with the popularization of mobile telephones, standardization and commercialization of the IP packet traffic in a third generation mobile telephone network (International Mobile Telecommunications 2000 (IMT-2000)) is also advancing and high-speed IP communications under a mobile environment is considered to become widespread.

Also, at highly public places (e.g., stations and shops), public wireless LAN (Local Area Network) connection service is being introduced rapidly. In addition, as the Internet access means of fixed or mobile hosts (terminals), low-cost and high-speed access means represented by ADSL (Asymmetric Digital Subscriber Line) is becoming widespread rapidly.

The great majority of access means used at public places are access means realized by mobile telephones (or data communication cards) that perform circuit switching or packet communication. Such access means has a limitation on communication speeds due to network properties. The communication speed of a so-called second generation mobile telephone network (such as PDC) is at around 9.6 to 64 kbps and the communication speed of the third generation mobile telephone network is at around 384 kbps in a moving state and at around 2 Mbps in a stationary state. This speed limitation becomes a limitation on the communication speeds with respect to communication environments of the mobile hosts.

Meanwhile, access means for accessing networks (such as the Internet) at high speed and at low cost will come into being in the near future. For instance, wireless public access means using various wireless LAN techniques, such as IEEE 802.11b, IEEE 802.11a, and Bluetooth, that are superior in communication speed to mobile telephones will be provided in the near future and enterprises, whose business is the provision of such access means, are appearing. That is, a movement for introducing wireless public access using the various wireless LAN techniques including IEEE 802.11a/b/g is advancing rapidly. Currently, the wireless LAN access enterprises already enter into actual operation, although they have problems in roaming, authentication, and the like.

In addition, “ubiquitous” becomes a key concept in recent years and access networks that use totally new systems suited to this concept are expected to come into existence in the future.

With this trend, there is a movement for allowing mobile telephone enterprises to provide wireless LAN access networks. For instance, a chip where an already-existing mobile telephone function and wireless LAN function are integrated with each other is under development. It is predicted that this chip will be provided to the mobile carriers and dual mobile hosts will appear in which the mobile telephone function and the wireless LAN function are integrated with each other. Wireless LANs and mobile telephones each have inherent characteristics as to the line speed, stability, and the like. Therefore, it is expected that the introduction of the wireless LANs will make progress for the sake of increasing the traffic volumes of the mobile telephones.

When the mobile telephone enterprises enter into wireless LAN business, they are required to solve the following problems.

(1) Security

As a weak point of general wireless LANs (such as IEEE 802.11 series), a problem is pointed out which concerns the confidentiality during access authentication and communication. This problem becomes significant when providing service by so-called “carrier grade” that has provided high communication safety until now. As means for solving this problem, a method is conceivable with which the mobile telephone enterprises construct dedicated access authentication and charging functions. The mobile telephone enterprises have constructed dedicated access authentication and charging functions for mobile telephone networks. These functions have high security levels as compared with the wireless LANs.

The authentication function is, however, one of functions that entail highest cost at the time of construction of commercial communication networks. Also, access systems based on standards, such as wireless LANs, are short in product-life cycle due to rapid technology progresses. Accordingly, when consideration is given to the profitability of business, it is difficult to spend a huge amount of money on the authentication function.

In addition, when multiple access lines that are not safe alone (lines that are not safe by themselves as distinct from the mobile telephones and the like) are possessed and use different protocols for authentication and encrypted communication, multiple certificates for certifying the legitimacy of a host are required and multiple authentication servers, whose number is equal to the number of the certificates, becomes necessary in order to issue the certificates. It is apparent that the results in high cost like above.

(2) Connection with Already-Existing Mobile Telephone Network

As distinct from a new enterprise that constructs a new access network, such as a wireless LAN, and starts business by itself, each already-existing mobile telephone carrier already possesses a mobile telephone network. Therefore, as one promising means that can be adopted by the mobile telephone carrier, it is possible to consider a method with which a function of connecting the already-existing mobile telephone network and a wireless LAN to each other is provided as unique value added service. However, it is conceivable, for instance, that an overlap between the service area of the mobile telephone network and the service area of the wireless LAN will occur in a future service mature period. Therefore, it is desirable that an effective function of “proper use” between communication means for the mobile telephone network and communication means for the wireless LAN is provided to a user.

By the way, as background art document information relating to the invention of this application, it is possible to cite the following information.

An access point apparatus is known which includes: notification means for notifying a network administrator administering a LAN of the presence of an authentication-requesting mobile station so as to gain the final authorization for an authentication procedure when a mobile station in the area performs the authentication procedure before the initiation of association such as security; and input means for allowing the network administrator to input an authentication-authorizing or -rejecting instruction with respect to the mobile station (see Patent Document 1, for instance).

A mobile communication service providing system including a mobile node, a foreign agent (FA), a home agent (HA), and a server system is known which includes control means for allowing the HA and FA to determine their packet transfer destinations. The server system includes: extraction means for extracting a service profile corresponding to the mobile node from a database managing the service profile containing information for providing service requested by the mobile node; service management means for editing the extracted service profile into a format in which the control means is capable of using the service profile; and distribution means for distributing the edited service profile to the HA and FA. The HA and the FA provide service using the control means in accordance with the distributed service profile (see Patent Document 2, for instance).

Also, as other background art documents relating to this application, it is possible to cite Patent Documents 3 and 4 given below.

Patent Document 1
JP 2001-345819 A (Paragraph 0015, FIGS. 1 and 3)

Patent Document 2
JP 2001-237878 A (Paragraph 0022, FIG. 3)

Patent Document 3
JP 2001-16634 A

Patent Document 4
JP 11-205342 A

### SUMMARY OF THE INVENTION

An object of the present invention is to provide a network access control technique that facilitates the introduction of an access network, such as a wireless LAN, as access means with respect to a core network.

Another object of the present invention is to provide a network access control technique with which it becomes possible to perform authentication of the use of an access network, such as a wireless LAN, by a terminal at a high security level.

Still another object of the present invention is to provide a network access control technique with which it becomes possible to perform charging with respect to the use of an access network, such as a wireless network, by a terminal with ease.

Yet still another object of the present invention is to provide a network access control technique with which it becomes possible to achieve cooperation between access networks.

That is, a network access control system according to the present invention includes:
a reception unit receiving an authentication request message sent from a terminal that is capable of utilizing a core network using a plurality of different types of access networks including a primary access network and a secondary access network, arriving at the core network via the primary access network, and containing a request for authentication of use of the secondary access network;
an authentication unit performing authentication processing in response to the request for authentication of the secondary access network; and
a transmission unit transmitting an authentication response message about the secondary access network that arrives at the terminal via the primary access network.

With the network access control system according to the present invention, the authentication of the secondary access network is performed using the authentication system of the primary access network. Therefore, the secondary access network is not required to possess its own authentication system. As a result, the introduction of the secondary access network becomes easy. In addition, it becomes possible to suppress operation cost.

The primary access network is a representative access network defined from among the multiple access networks that the terminal is capable of using and includes an authentication function. In contrast to this, the secondary access network is a concept relative to the primary access network and each remaining access network, out of the multiple access networks, that has not been defined as the primary access network corresponds to the secondary access network. The secondary access network has no authentication function or has an authentication function whose security level is lower than or equal to that of the authentication function of the primary access network. With this configuration according to the present invention, the authentication of the secondary access network is performed by the authentication function of the primary access network, so it becomes possible to perform the authentication of the secondary access network at a high security level. In addition, the primary access network may further include a charging function.

Also, a network access control system according to the present invention may be configured such that the authentication request message further contains a request for authentication of use of the primary access network, the authentication unit performs the authentication processing for the request for the authentication of the use of the primary access network and the secondary access network, and the transmission unit transmits the authentication response message about the primary access network and the secondary access network to the terminal.

With this configuration, it becomes possible to perform the authentication of the secondary access network concurrently with the authentication procedure of the primary access network.

Also, a network access control system according to the present invention may be configured such that when the authentication unit authenticates the use of the secondary access network, the transmission unit transmits the authentication response message containing use permission information about the authenticated secondary access network and the terminal informs the authenticated secondary access network of information for the use of the authenticated secondary access network.

With this configuration, it becomes possible for the terminal to connect to the secondary access network and to perform communication using the secondary access network.

Also, a network access control system according to the present invention may preferably be configured to further include a network control unit controlling the core network so that communication service using the secondary access network authenticated by the authentication unit and the core network is provided in accordance with a use condition specified in a contract concluded in advance by a user of the terminal for the authenticated secondary access network.

With this configuration, it becomes possible to provide a user of the terminal with communication service using the secondary access network in accordance with the use condition.

A network access control system according to the present invention may preferably be configured such that the network control unit, for instance, informs an edge node accommodating an access line of the authenticated secondary access network to be used by the mobile host of control information for providing the communication service to the terminal in accordance with the use condition.

Also, a network access control system according to the present invention may preferably be configured to further include a charging (billing) unit performing processing relating to both measured charge (volume-based billing) for use of the core network by the terminal using the primary access network and measured charge (volume-based billing) for use of the core network by the terminal using the secondary access network.

With this configuration, measured charge with respect to the primary access network and measured charge with respect to the secondary access network are performed by a common charging system, so the introduction of the secondary access network is facilitated and it becomes possible to suppress operation cost. In this case, from the viewpoint of cost suppression, it is preferable that an already-existing charging system for the primary access network is modified so as to be applicable also to the secondary access network.

A network access control system according to the present invention may preferably be configured such that the charging unit includes: a charging unit informing unit informing the edge node accommodating the access line of the authenticated secondary access network to be used by the terminal of a charging unit for performing the measured charge for the use of the secondary access network by the terminal; and a calculation unit calculating a charge amount based on an amount in the charging unit relating to the terminal that the edge node measured in accordance with the charging unit.

Also, a network access control system according to the present invention may preferably be configured such that the authentication unit performs authentication processing of the secondary access network for the roaming user in cooperation with an authentication system of a roaming source when the reception unit received an authentication request message containing a request for the authentication of the secondary access network from a terminal of a roaming user via the primary access network, and the transmission unit transmits an authentication response message about the authentication processing for the roaming user to the terminal of the roaming user via the primary access network.

With this configuration, it becomes possible to provide the roaming user with the use of the primary and secondary access networks through the network access control system according to the present invention.

In this case, a network access control system according to the present invention may preferably be configured such that when the authentication processing for the roaming user by the authentication unit has ended normally, the network control unit informs an edge node accommodating an access line of the authenticated secondary access network to be used by the terminal of the roaming user of control information for providing communication service in accordance with a use condition set by the roaming user for the secondary access network.

Also, a network access control system according to the present invention may preferably be configured such that the authentication request message is transmitted from the mobile host when the number of access networks that the terminal is capable of using has changed through a movement of the terminal in a range where the primary access network is usable, and contains at least a request for authentication of an access network that has become usable, the network control unit judges whether access network switching should be performed for the terminal with reception of the authentication request message by the reception unit as a trigger, the authentication unit performs authentication processing of a switching destination access network, and the transmission unit transmits an authentication response message about the switching destination access network authenticated by the authentication means to the terminal via the primary access network.

With this configuration, it becomes possible to perform access network switching when the terminal has become capable of using another access network (secondary access network) as a result of its movement.

In this case, a network access control system according to present invention may preferably be configured such that the network control unit judges whether the access network switching should be performed in accordance with at least one of contents of the contract concluded by the user of the terminal and a current network state.

With this configuration, it becomes possible to avoid access network switching when the switching is undesirable.

Also, a network access control system according to the present invention may preferably be configured such that when a plurality of secondary access networks are selectable as the switching destination, the network control unit determines the switching destination access network based on at least one of contents of the contract concluded by the user of the terminal and a current network state.

With this configuration, it becomes possible to perform switching to the most appropriate switching destination access network.

Also, a network access control system according to the present invention may preferably be configured such that the transmission unit transmits the authentication response message containing use permission information about the switching destination access network to the terminal in accordance with a result of the authentication of the switching destination access network by the authentication unit and the terminal informs the switching destination access network of information for use of the switching destination access network, and the network control unit informs an edge node accommodating an access line of the switching destination secondary access network to be used by the terminal of control information for providing communication service to the terminal in accordance with a use condition specified in a contract concluded in advance by the user of the terminal for the switching destination access network so that communication service using the switching destination access network and the core network is provided in accordance with the use condition.

In this case, a network access control system according to the present invention may preferably be configured such that when the communication service is provided in cooperation between a switching source edge node and the switching destination edge node, the network control unit informs each of the switching source edge node and the switching destination edge node of control information for providing cooperation service.

With this configuration, it becomes possible to provide the user of the terminal with the cooperation service.

Also, a network access control system according to the present invention may preferably be configured such that the network control unit transmits control information for providing communication service, in which even after the access network switching, communication quality before the switching is maintained, to an edge node accommodating the switching destination access line.

With this configuration, it becomes possible to suppress the degradation of the communication quality due to the switching.

Also, a network access control system according to the present invention may preferably be configured such that during use of the same access network by the terminal, at the time of switching of an edge node accommodating an access line of the access network used by the terminal, the network control unit transmits control information to the switching destination edge node, which is the same as control information transmitted to the switching source edge node.

With this configuration, it becomes possible for the user of the terminal to receive, even after the edge node switching, service that is the same as that provided before the switching.

Also, a network access control system according to the present invention may preferably be configured such that the network control unit receives traffic information from an edge node accommodating an access line used by the terminal and, when the traffic exceeds a predetermined threshold value, requesting the terminal to perform access network switching.

With this configuration, it becomes possible to avoid an influence of congestion of traffic or the like through the access network switching.

Also, a network access control system according to the present invention may preferably be configured such that the network control unit monitors a position of the terminal and, when the terminal has moved to a position at which the terminal is capable of using a predetermined secondary access network, issues a notification to the terminal.

With this configuration, even when the terminal does not search for a position at which the secondary access network is usable, it becomes possible to appropriately perform the switching (transition) to the secondary access network.

Also, a network access control system according to the present invention may preferably be configured such that the reception unit receives the authentication request message containing state information of the terminal from the terminal, and the network control unit judges whether access line switching should be performed for the terminal based on the state information.

Also, a network access control system according to the present invention may preferably be configured such that the reception unit receives the authentication request message containing designation information designating the switching destination access network from the terminal, and the network control unit determines the access network designated by the designation information as the switching destination access network.

With this configuration, it becomes possible to perform switching to an access network desired by the user of the terminal.

In addition, it is possible to carry out the present invention as an authentication server having the functions of the reception unit, the authentication unit, and the transmission unit constituting the network access control system described above and an access control server having the function of the network control unit of the network access control system. Also, it is possible to carry out the present invention as a terminal that uses multiple types of access networks through a network access control system. Further, it is possible to carry out the present invention as a network access control method having the features described above.

### BRIEF DESCRIPTION OF THE DRAWINGS

FIG. 1 shows an example of a network configuration according to an embodiment;

FIG. 2 shows a structure of an access control profile;

FIGS. 3A and 3B show an example of an access control profile (common profile, ACP-C);

FIGS. 4A and 4B show an example of an access control profile (individual profile, ACP-V);

FIG. 5 is an explanatory diagram of an example of an operation relating to an access authentication system;

FIG. 6 is a sequence diagram showing an example of an access control procedure;

FIG. 7 shows an example of a format of an authentication request message in the case of integration with authentication of a primary access line;

FIG. 8 shows an example of a format of an authentication request message (unique message) in the case of non-integration with the primary access line authentication;

FIG. 9A shows examples of functional configurations of an authentication server AAA and an access control server ACS and FIG. 9B shows an example of a functional configuration of an access control apparatus AAA/ACS;

FIG. 10 is a table showing an example of elements of a different type access line cooperation information database;

FIG. 11 is a sequence diagram showing an example of secondary access line authentication processing at the authentication server AAA and the access control server ACS;

FIG. 12 shows an example of an operation for achieving a common charging target information collection function;

FIG. 13 shows an example of a configuration of an edge node apparatus (EN);

FIG. 14 is a sequence diagram showing access control profile reception processing at the edge node apparatus;

FIG. 15 shows an example of access control with respect to roaming from another network provider (another carrier);

FIG. 16 shows an example of an operation in an access line selection basic system;

FIG. 17 is a flowchart showing an access network selection mechanism;

FIG. 18 is also a flowchart showing the access network selection mechanism;

FIG. 19 shows an example of an operation of an access permission procedure;

FIG. 20 is an explanatory diagram of an example of an operation relating to service continuation cooperation at the time of inter-access-line movement;

FIG. 21 shows an example of a switching occurrence request message from the edge node to the access control server;

FIG. 22 shows an example of an operation relating to access line switching performed in accordance with a peripheral network resource state;

FIG. 23 shows an example of an operation relating to automatic access line capturing performed in accordance with a contract condition of a user;

FIG. 24 is a table showing an example of mobile host information;

FIG. 25 shows an example of an operation relating to access line capturing based on a user terminal requirement;

FIG. 26 is a table showing an example of application/function types;

FIG. 27 shows an example of an operation relating to access line automatic switching depending on the type of an application to be used;

FIG. 28 shows an example of a configuration of a network access terminal (mobile host);

FIG. 29 shows an example of a secondary access line authentication procedure at the network access terminal;

FIG. 30 is a table showing an example of charging information;

FIG. 31 shows an example of a format of an authentication response message in the case of integration with the primary access network authentication;

FIG. 32 shows an example of a format of an authentication response message in the case of non-integration with the primary access network authentication;

FIG. 33 shows an example of a format of an authentication completion and access permission request message;

FIG. 34 shows an example of a format of an access line change request message; and

FIG. 35 is a sequence diagram showing an example of an operation of the access control apparatus (AAA/ACS).

### DESCRIPRION OF THE PREFERRED EMBODIMENTS

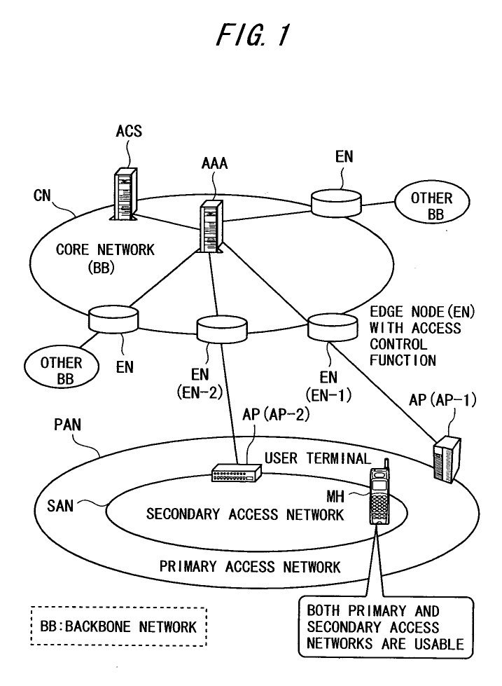

Hereinafter, embodiments of the present invention will be described with reference to the accompanying drawings. A configuration in the embodiment is merely an example and there is no intention to limit the present invention to the configuration in the embodiment.

<1> Outline of Network Access Control System (FIG. 1)

FIG. 1 shows an embodiment of a network access control system according to the present invention. The embodiment shown in FIG. 1 is mainly configured in the manner described below. Multiple wireless access networks are accommodated with respect to a core network (CN) (example of which is a Backbone network (BB)) of a Network Operator (NOP) (also referred to as the “carrier”). As shown in FIG. 1, the CN is connected to the CN of at least one of the other carriers (BB of the other carrier). The network system formed by the CN and the multiple wireless access networks provides users (subscribers) with communication service that uses the core network via the wireless access networks.

As the wireless access networks, it is possible to use various wireless access networks. For instance, it is possible to use a wireless access network (Radio Access Network (RAN)) based on the third generation mobile telephone standard (IMT-2000 (W-CDMA, cdma2000, or the like)) or the second generation mobile telephone standard (Personal Digital Cellular (PDC)), cdmaOne, or the like), a wireless LAN network such as IEEE802.11a/b/g or HiSWAN, a PHS (Personal Handyphone System) network, Bluetooth, or the like.

One of the multiple wireless access networks connected to the CN is defined as a primary access network (PAN) and each of the other wireless access networks is set as a secondary access network (SAN). The PAN is an access network where at least an access authentication system for authentication of user access to the wireless access networks has been constructed. As a matter of course, it is desirable that an access network, in which the constructed authentication system ensures a sufficient security level for the provision of commercial service, be selected as the PAN. For instance, as an example of an access network that is desirable to be selected as the PAN, it is possible to cite a second or third generation mobile telephone network (PDC, IMT-2000 (e.g., FOMA (registered trademark)), or the like) that is provided in already-existing commercial service and includes an access authentication and charging system where a certain security level is ensured. The PAN is determined by the carrier of the CN, for instance.

On the other hand, the SAN is an access network which has no access authentication system, or the network has an access authentication system but whose security level is lower than that of the access authentication system of the access network defined as the PAN. In addition, the SAN has at least one area (service area) that the user is capable of using concurrently with the PAN. It is desirable that every service area of the SAN be included in the service area of the PAN.

It should be noted that the access networks (PAN and SAN) with respect to the CN may contain a fixed access network such as an xDSL network.

As an example of a terminal (fixed or mobile terminal) used by the user (subscriber) in order to receive the provision of the communication service, it is possible to cite a mobile host (MH) (also referred to as the “mobile node (MN)”, “user terminal”, or “subscriber terminal”). As the mobile host, a mobile terminal (or mobile station) is used which is capable of connecting to each of the various types of access networks including the PAN and is further capable of using communication service that uses the CN via the respective access networks. That is, the terminal is capable of selecting and using multiple access systems.

It is possible to form the network access control system using an authentication server (Authentication, Authorization and Accounting (AAA)) and an access control server (ACS) accommodated in the CN on a network side, for instance. With this configuration, the network access control system controls multiple edge node apparatuses (ENs) respectively corresponding to the multiple wireless access networks.

In the example shown in FIG. 1, the ACS and the multiple ENs are connected to the AAA. It is possible to form the AAA and the ACS using at least one computer where the functions of these servers have been combined with each other. That is, the functions of the AAA and the ACS may be realized through execution of various programs stored in a storage device by at least one computer. In other words, it is possible to form the AAA and the ACS as an access control apparatus (AAA/ACS) by combining the functions of the AAA and the ACS with each other.

It should be noted that the AAA corresponds to the reception unit, the authentication unit, and the transmission unit in the present invention, and the ACS corresponds to the network control unit in the present invention. Note that the reception unit, the authentication unit, the transmission unit, and the network control unit according to the present invention may be realized in cooperation between the AAA and the ACS.

The ENs respectively corresponding to the multiple access networks are each formed by adding a function of performing user access control to a router or a Layer 3 switch disposed in a peripheral portion (boundary) of the CN. The access control function is, for instance, realized through execution of a program for function realization stored in storage device of a processor by the processor (CPU or the like) incorporated into the router or the Layer 3 switch.

Each EN accommodates one or more access lines of its corresponding wireless access network and is connected to an access point (AP) installed in each of the wireless access networks through the access lines.

That is, the EN (EN-1) connected to the PAN accommodates at least one access line (primary access line (PAL)) of the PAN, and the EN (EN-2) connected to the SAN accommodates at least one access line (secondary access line (SAL)) of the SAN.

The wireless access networks respectively corresponding to the PAN and the SAN are each equipped with at least one access point AP that also serves as a base station. The EN (EN-1) connected to the PAN is connected to the AP (AP-1) of the PAN, and the EN (EN-2) connected to the SAN is connected to the AP (AP-2) of the SAN.

It is possible for the terminal (MH) to have the following functions. The functions described below are, for instance, realized through execution of programs for function realization stored in storage device of a processor by the processor incorporated into the MH.

(a) An access line control function that supports multiple access systems for connection to the CN (connection systems corresponding to the access networks).

(b) A function of selecting an access line (access system) to be used in accordance with an instruction from the user or the network side.

(c) A function (authentication request control unit) of, at the time of connection authentication with respect to the access line (PAL) of the representative wireless access network (PAN) defined on the network side among the multiple types of access lines (access systems) that the MH is capable of using, adding authentication information concerning another access line (access line of the SAN (SAL)) to an authentication request with respect to the PAL and sending out a resultant request.

(d) A message processing function (message processing unit) and an authentication information management function (authentication information management unit) of passing access authentication information (use permission information) with respect to the SAL received from the network side to its corresponding access line control function through an access authentication procedure with respect to the PAL between respective access line control functions (between the access line control function for the PAL and the access line control function for the SAL) within the MH.

On the other hand, the AAA on the network side has at least the following function.

(e) A function (authentication information extraction unit) of receiving and analyzing an authentication request transmitted from the MH and extracting authentication information concerning the access line that the MH is capable of using.

Also, the ACS has at least the following functions.

(f) An access network selection function (access line type selection unit) of selecting the best-suited switching destination access line type based on a use condition of the user (access line type given a higher priority for connection under a contract, for instance) or the current network state.

(g) A function (access control profile delivery unit) of delivering, when a switching destination access line is recognized, an access control profile (ACP), in which access control information unique to the access line is described, to the EN that accommodates the access line.

(h) A function (access control profile registration unit) of registering each ACP for a user (where an access line use condition determined at the time of contract for the use of service is described) in an access control profile database (ACP-DB) that the ACS is capable of using.

Also, on the network side, it is possible for both of the EN (EN-1) connected to the AP-1 of the PAN and the EN (EN-2) connected to the AP-2 of the SAN to have the following function.

(i) An access control profile management function (access control profile management unit) of storing individual service information (ACP-V) transmitted from the AAA or the ACS only for a given validity period.

It should be noted that after the access line authentication procedure with respect to the MH, the CN performs packet canalization, service control, and the like concerning the user (MH).

The network access control system provides the MH of the user with communication service that uses the CN by connecting to a predetermined access line. This communication service is provided on the condition that a wireless access network that the user uses has been authenticated on the network side, and is performed in accordance with the contents of access control (use condition) with respect to the wireless access network used by the user.

As a major feature, the network access control system is configured so that the necessity for the SAN to possess its own authentication system is eliminated by performing authentication with respect to the SAN using a PAL authentication procedure. Also, the network access control system is characterized in that charging with respect to the use of the SAL by the user is performed using a charging system for the PAL.

Also, as another feature, the network access control system provides means for selecting an access line that the user should use in accordance with the contract condition with the user or a judgment made by the carrier itself while giving consideration to the network connection state of the user (MH) or the like.

The original of the ACP is registered in the ACS-DB after a communication service subscribing contract is concluded (service use condition is determined) between the user and the carrier, and is delivered to the EN that accommodates the access line that is the control target with the authentication procedure executed at the time of the use of the CN by the MH as a trigger. As a technique of delivering the ACP, it is possible to use a technique disclosed in JP 2001-237878 A, for instance.

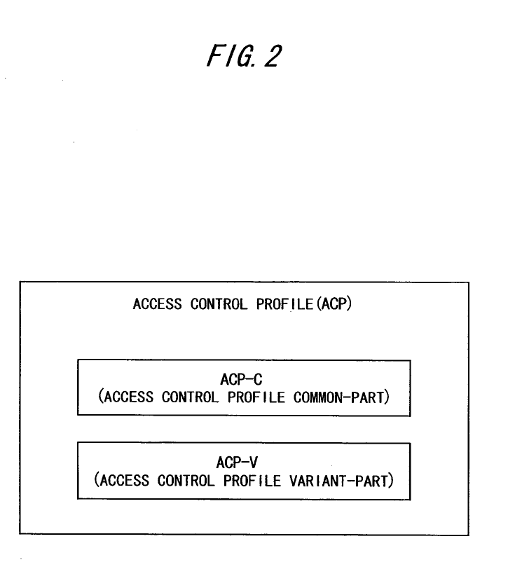

It should be noted that in this embodiment, as the carrier of the wireless access network, a mobile virtual network operator (MVNO) that does not possess certain access means (wireless access network) for itself and provides subscribers with service using a wireless access network rented from a carrier is assumed to be the one in addition to a carrier of the CN and a carrier that possesses the facilities of the wireless access network.

<2> Access Control Profile (FIGS. 2, 3, and 4)

Next, the access control profile (ACP) that is used for network control in the network access control system will be described. In the network access control system, the ACP that describes the access line type usable by the user of the MH and the use requirement of the user, such as selection logic like a priority order, is defined under a subscribing contract between the user and the carrier and is held/managed on a carrier side (network side). Then, the network access control system selects an access line that the user should use with reference to a data set (that is, the ACP) that makes it possible to perform access line connection control based on the access line use condition for each user.

Each ACP for a user defines the contents of access control for the user. Information defined in the ACP includes the following elements, for instance.

(1) One or more usable access line types.

(2) A priority order between the one or more usable access line types.

(3) The presence or absence of access line automatic selection.

(4) A handover level.

Also, it is possible for the ACP to include the following two subsets (subcategories).

(i) Access Control Profile Common-Part (ACP-C)

In the ACP-C, the access line types that the user is capable of using, the contract information of the user common to these access lines, and the like are defined. The ACP-C is stored in the ACS-DB and is referred to by the AAA and/or the ACS.

(ii) Access Control Profile Variant-Part (ACP-V)

In the ACP-V, for each access line that the user is capable of using, the use condition of the access line and a relation (priority order, cooperation contents, and the like) with each of other access lines that is usable within a contract range are defined. The ACP-V is stored in the ACP-DB so as to be associated with the ACP-C. Alternatively, the ACP-V is generated based on the definition contents of the ACP-C, a network state, or the like as necessary. The ACP-V is delivered to the EN accommodating the access line that the MH uses with an authentication request of the MH with respect to the access line or the like as a trigger, and is stored and held in the EN. The EN refers to the received ACP-V and performs access control with respect to the MH in accordance with the contents of the ACP-V. At this time, it is possible for the EN to recognize a cooperation relation with each of other access lines by referring to the ACP-V and to perform necessary cooperation processing.

As described above, an ACP (ACP-C and ACP-V) is defined for each user and is stored in the ACP-DB. The ACP-V is extracted by the ACS as additional data and is delivered to and held in its corresponding EN at the time of connection authentication of the MH with respect to an access line. The EN has an access control function and the access control function of the EN performs access control in conformance with a rule defined in the ACP-V.

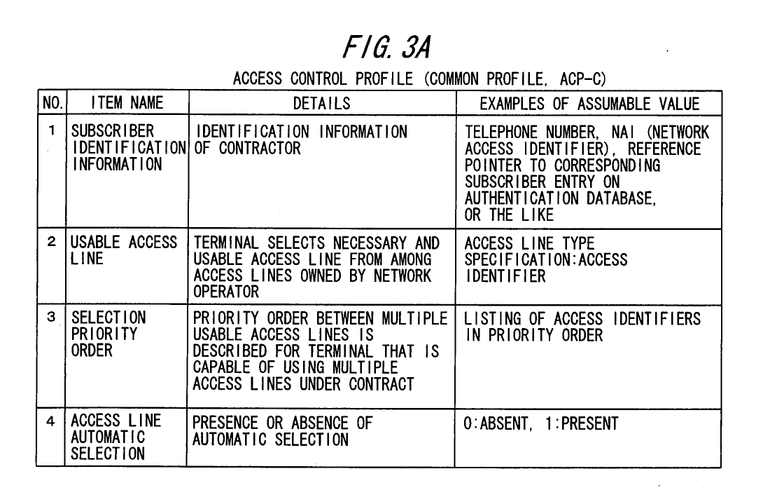

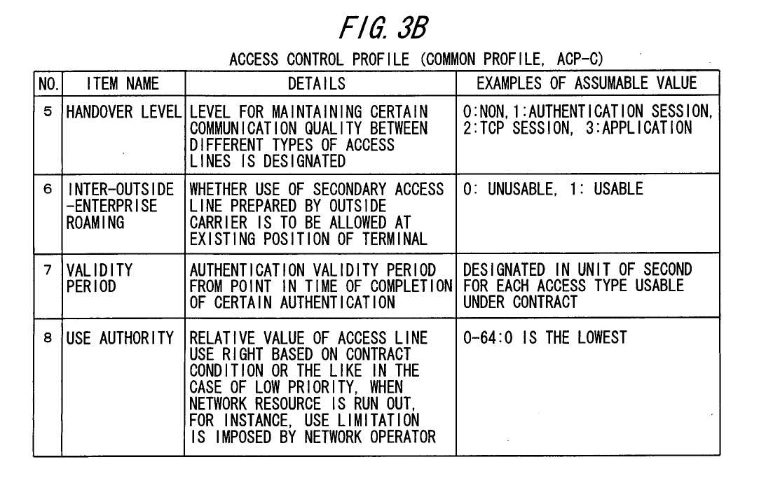

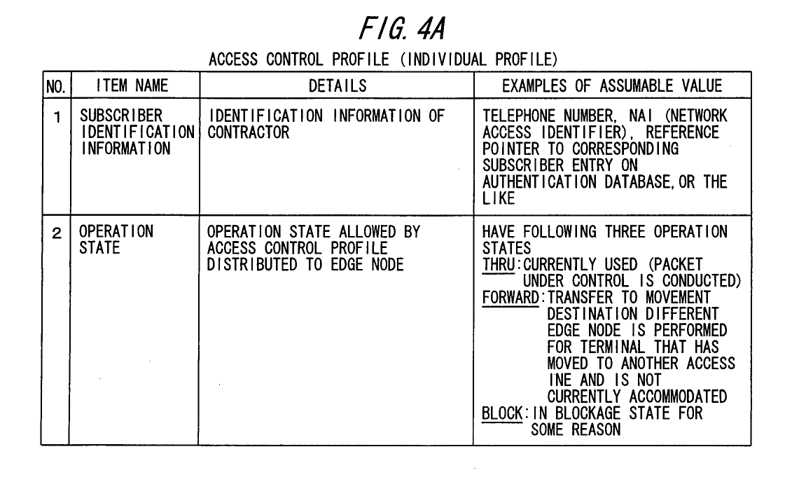

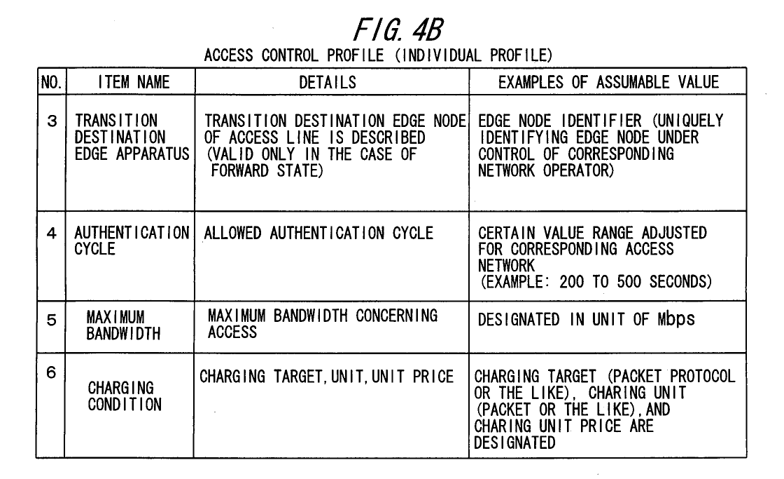

FIG. 2 shows a structure of the ACP, FIGS. 3A and 3B show an example of the ACP-C, and FIGS. 4A and 4B show an example of the ACP-V. As shown in FIG. 2, the ACP is composed of the ACP-C and the ACP-V. As shown in FIGS. 3A and 3B, the ACP-C contains at least subscriber identification information (NAI or the like) and one or more usable access line types and may further contain selection priority order between access lines, the presence or absence of access line automatic selection, a handover level, outside enterprise roaming, an authentication session validity period, and information relating to use authority.

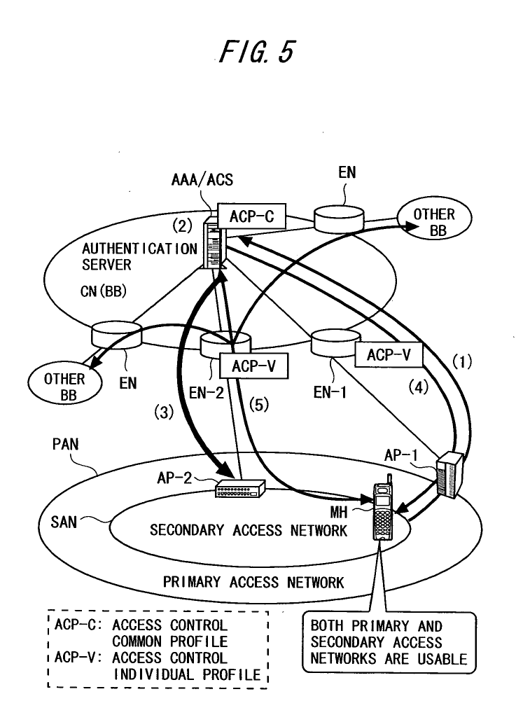

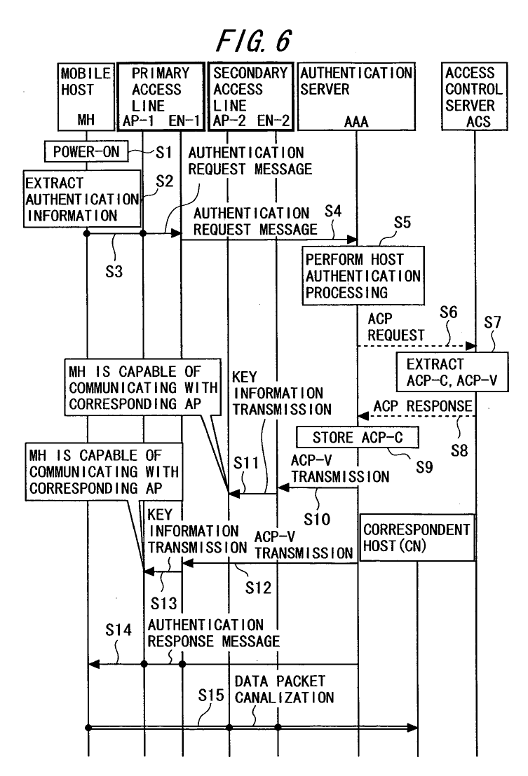

On the other hand, the ACP-V is prepared for each access line type and, as shown in FIGS. 4A and 4B, may contain subscriber identification information, an operation state (currently used (packet conduction)/transfer/blockage), a transition (transfer) destination edge apparatus, an authentication cycle, the maximum band, and information relating to a charging condition. The ACP-C and the ACP-V each have a data structure composed of fields for the respective information elements and values that the information elements may assume.

<3> First Access Authentication System (FIGS. 5 and 6)

Next, as a user access authentication system in the network access control system, processing (first access authentication system) will be described in which authentication with respect to multiple access lines is integrated into one authentication procedure and is performed through the authentication procedure.

The first access authentication system (hereinafter referred to as the “first system”) is a procedure where at the MH that is capable of using multiple access lines, through a connection authentication procedure with respect to a certain access line, a connection permission with respect to the access line and a connection permission with respect to another access line are received from the network side. For instance, it is possible to perform connection authentication of the SAL concurrently with connection authentication of the PAL, through an authentication procedure for connection to the PAL.

Therefore, the mobile host MH adds information necessary for authentication of a certain SAL to an authentication request message with respect to the PAL and transmits a resultant message to the CN. In response to the message, the network access control system integrates authentication procedures with respect to the access lines of both of the PAL and the SAL with each other and performs the integrated authentication procedure.

When an MH having connection means to multiple access lines dynamically perform proper use of the respective access lines (transition from a certain access line to another access line), it is required to perform an authentication procedure using an authentication system prepared separately from that for the line before the transition at the time of connection to the transition destination line. The first system solves this problem.

In the first system, when a certain MH is capable of using multiple access lines based on a contract, authentication procedures with respect to the multiple access lines are integrated into any one of the authentication procedures. To do so, each of the apparatuses on the user side (MH side) and the network side relating to the network access control system has the following functions.

The MH includes an authentication request message sending out function (authentication request message sending out unit) and an authentication response message processing function (authentication response message processing unit).

With regard to the authentication protocol control function (contained in the access line control function) concerning a certain access line (first access line (PAL, for instance)), the authentication request message sending out function adds authentication information concerning not only the access line but also another coexisting access line (second access line (SAL, for instance)) to an authentication request message for the access line and sends out a resultant message. The MH is equipped with a storage device where authentication information as to each access line that the user is capable of using is stored.

With regard to the authentication protocol control function concerning a certain access line, the authentication response message processing function receives the authentication response message form the AAA, and extracts use permission information (packet encryption key, for instance) of another access line contained in the authentication response message, and holds (caches) the extracted information in the storage device of the MH.

On the other hand, on the network side, the AAA has an authentication request message processing function (authentication request message processing unit).

The authentication request message processing function is a part of the authentication protocol control function of the AAA. The authentication request message processing function extracts the authentication information for the second access line from the authentication request message with respect to the first access line from the MH and performs an authentication operation. In addition, the authentication request message processing function adds an authentication response (use permission information) of the second access line to an authentication response message (authentication confirmation message) with respect to the first access line and returns the resultant message to the MH.

In addition, the network side has a function of setting the AP accommodating the SAL so that the MH authenticated as to the first and second access lines (permitted to use the access lines) is capable of using the access lines.

FIG. 5 shows an example of the first access authentication system. In FIG. 5, an example of an operation in the case where the authentication of the SAL is performed using the PAL authentication procedure is shown. Note that in FIG. 5, the access control apparatus (AAA/ACS) where the function of the AAA and the function of the ACS are integrated with each other is shown.

In FIG. 5, first, the MH detects that the MH is capable of connecting to the PAL and the SAL, generates an authentication request message for the PAL containing authentication information for the SAL, and transmits the generated message ((1) in FIG. 5). The MH detects that it is capable of connecting to the PAN and the SAN by, for instance, receiving radio waves from the PAN and the SAN.

The AAA/ACS receives the authentication request message via the AP-1 and the EN-1 corresponding to the PAN, analyzes the received authentication request message, and performs an authentication operation relating to the PAL and the SAL. At this time, the AAA/ACS detects that the MH is accessible also to the SAL ((2) in FIG. 5). It is possible to perform this detection processing based on the definition contents of (use condition in) the ACP of the user of the MH, the current network state (including the state of the MH), and the like.

Next, when a result of the authentication of the PAL and the SAL is positive, the AAA/ACS transmits a message ordering to permit access by the MH to the AP (AP-2) corresponding to the SAL ((3) in FIG. 5). This message containing the use permission information with which the AP permits access from the MH, is transmitted to the AP-2 via the EN (EN-2) corresponding to the SAL, and is managed by the AP-2.

On the other hand, in order to inform that the authentication results of both the PAN and the SAL are positive, the AAA/ACS generates an authentication response message for the PAL containing the use permission information of the PAL and the SAL and transmits the generated message to the MH ((4) in FIG. 5). This authentication response message arrives at the MH via the PAL. Then, MH obtains the use permission information of the PAL and the SAL from the message and caches the obtained information. Following this, the MH connects to the SAL using the cached use permission information and becomes capable of receiving the provision of communication service using the CN (packet communication via the CN, for instance) ((5) in FIG. 5).

FIG. 6 is a sequence diagram showing another operation example of the first access authentication system by the network access control system. Note that in the operation example shown in FIG. 6, an operation relating to the first system is performed in cooperation between the AAA and the ACS. The operation example in FIG. 6 will be described below.

The MH is powered on at an existing position (within a PAN usable range (service area)) (step S1). Then, an authentication request message for the PAL is generated in the MH. At this time, authentication information for every other access line (at least one SAL) that is usable at the existing position of the MH is extracted from the storage device in the MH and is added to the authentication request message for the PAL (step S2). Next, the MH sends out the authentication request message for the PAL (step S3). The authentication request message is transferred to the edge node EN-1 of the CN via the PAN.

On receiving the authentication request message for the PAL, the edge node EN-1 finds an AAA that is capable of authenticating the MH corresponding to the issuer the authentication request message and transfers the authentication request message to the AAA (step S4).

On receiving the authentication request message, the AAA authenticates the legitimacy of the MH that is the issuer of the authentication request through authentication processing based on the authentication request, thereby judging whether it is possible to permit access to the PAL and the SAL that is an authentication target (step S5).

When judging that the MH is legitimate through the authentication processing, the AAA sends out a message (ACS request message) requesting the ACP corresponding to the MH (user) to the ACS (step S6).

On receiving the ACS request message, the access control server ACS permits the MH to access the SAL that is usable at the existing position of the MH. Therefore, the access control server ACS extracts the ACP-C of the user from the ACP-DB and also extracts access line type information usable at the existing position of the MH (application access line information corresponding to an area code indicating the existing position) from a different type access line information database (to be described later). Note that as to the detection of the existing position, it is possible to adopt a technique (position registration procedure) used in the already-existing mobile telephone network.

Then, the ACS checks each SAL access line type described in the ACP-C against each access line type extracted from the different type access line database, thereby selecting each access line type that the MH is capable of using at the existing position (step S7).

It should be noted that when the ACP-C contains an incidental condition such as a priority order between access lines, at least one SAL access line type may be selected in accordance with the incidental condition. For instance, when multiple matching access line types are found between databases, an access line having the highest priority may be selected.

Following this, the ACS generates an ACS response message containing the ACP (ACP-C and ACP-V) concerning the MH identified by the ACS request message and returns the generated message to the AAA (step S8). The ACP contained in the ACS response message includes the ACP-C, the ACP-V corresponding to the PAL, and the ACP-V corresponding to each selected access line type (SAL). In this embodiment, as an example, it is assumed that the ACS response message contains the ACP-Vs respectively corresponding to the PAL and one SAL.

On receiving the ACS response message, the AAA stores the ACP-C among the ACPs contained in the ACS response message into a management table in a storage device of the AAA (step S9).

Then, the AAA transmits the multiple ACP-Vs in the ACS response message to the ENs accommodating the access lines associated with the ACP-Vs (access lines respectively corresponding to the PAL and the SAL) That is, the AAA transmits the ACP-V for the SAL to a corresponding EN (EN-2) (step S10).

On receiving the ACP-V for the SAL, the EN-2 stores the ACP-V in a management entry of a management table prepared in the storage device of the EN-2. In addition, the EN-2 extracts information that should be referred to at the AP-2 corresponding to the EN-2 (sub-information of the ACP-V (for instance, a packet encryption key used in a wireless section (between the MH and the AP2))) and transmits the extracted information to the AP-2 (step S11).

The AP-2 under control by the EN-2 (the AP-2 performs control of packet transmission permission/prohibition with respect to the MH) receives the sub-information contained in the ACP-V and concerning the MH as the use permission information and stores the received information. As a result, the AP-2 becomes capable of permitting access from the MH to the SAL.

Also, the AAA transmits the ACP-V corresponding to the PAL to the EN-1 (step S12). On receiving the ACP-V for the PAL, the EN-1 performs the same operation as the EN-2 and transmits information that should be referred to at the AP-1 corresponding to the EN-1 (sub-information of the ACP-V (for instance, encryption key in a wireless section)) to the AP-1 (step S13). The AP-1 under control by the EN-1 (the AP-1 performs control of packet transmission permission/prohibition with respect to the MH) receives the sub-information of the ACP-V concerning the MH and stores the received information. As a result, the AP-1 becomes capable of permitting access from the MH to the PAL.

It should be noted that the operations in steps S10 and S11 are paired operations and the operations in steps S12 and S13 are also paired operations. Also, the number of transmission destinations of the ACP-Vs depends on a judgment condition of the ACS (the number of access lines selected). Further, each ACP-V may be directly transmitted to its corresponding EN from the ACS. Still further, the sub-information (access permission message) transmitted from the EN to the AP may be held by the EN in advance or the EN may transfer the sub-information transmitted from the AAA to the AP.

By the way, after performing the authentication processing, the AAA generates an authentication response (authentication confirmation) message containing the use permission information (packet encryption key, for instance) with respect to the PAL and the SAL and transmits the generated message to the MH. The authentication response message is transferred to the MH via the EN-1 and the AP-1 (PAL) and is received by the MH.

On receiving the authentication response message, the MH fetches the use permission information from the received message and holds and manages the fetched information. As a result, the SAL access line control function in the MH becomes capable of performing communication that uses the SAL using the use permission information concerning the SAL.

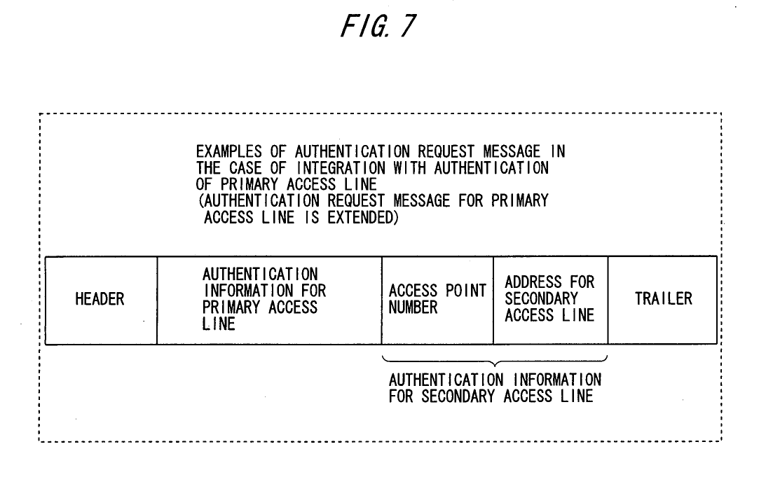

FIG. 7 shows an example of a packet (authentication request packet) of the authentication request message sent out from the MH. In FIG. 7, the authentication request packet contains authentication information for the SAL in addition to authentication information for the PAL as payloads.

The authentication information for the SAL may contain the access point number of the SAL and the address for the SAL in addition to the user identification information (such as a user name and a password (not shown)). Here, when multiple usable SALs exist at the existing position, the SAL authentication information corresponding to each SAL is set as a payload.

The AP number of the SAL is a number for identifying the access point of the SAL. Also, the address for the SAL is the address of the MH corresponding to the destination address of a packet via the SAL (c/o address in the case of mobile IP, for instance). The contents of the authentication information for the PAL are approximately the same as those of the authentication information for the SAL.

It should be noted that in the first access authentication system, it is sufficient that the authentication information for the SAL is added to the authentication request message for the PAL. Therefore, the type (kind) of the PAL does not matter.

As described above, according to the network access control system, authentication with respect to a specific access line is integrated with an authentication procedure for another access line and the authentication of these access lines is performed substantially at the same time.

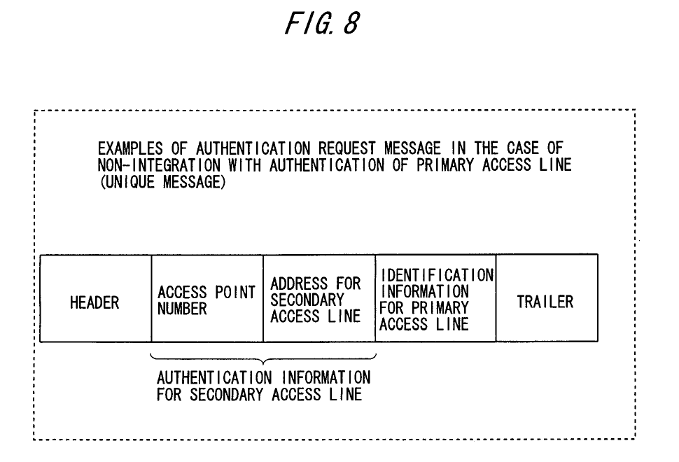

As a result, even when the specific access line does not have its own authentication system, it is possible to perform the authentication of the specific access line using the already-existing authentication system of the other access line. Accordingly, on the network side, when switching between different types of access networks (access lines) is performed, it is possible to perform an authentication procedure for a switching destination access network without using a unique authentication system. Also, it is possible to achieve a reduction in cost required when a specific access network is introduced as an access network of a core network.

<4> Second Access Authentication System (FIGS. 5 and 8)

Next, a second access authentication system (hereinafter referred to as the “second system”) by the network access control system according to the present invention will be described.

The second system is processing relating to SAL authentication that is not integrated with PAL authentication. That is, the second system is provided with a connection authentication means for subjecting an MH that is capable of using multiple access lines to the connection authentication of the multiple access lines that can be used by the MH. In the second system, in the integrated authentication procedure (first system) where a connection authentication procedure for a certain access line (PAL, for instance) is set so as to be commonly usable for authentication of at least one other access line (SAL, for instance), an authentication request with respect to the other access line is sent out using the authentication procedure for the certain access line but its trigger for transmission to a network is set independent of a trigger of authentication of the certain access line. With this configuration, it becomes possible to execute the connection authentication of the certain access line and the connection authentication of the other access line independently of each other as necessary.

In the first access authentication system, the connection authentication of the PAL and the connection authentication of the SAL are, for instance, integrated into a PAL authentication trigger (authentication session start timing) and are executed through the authentication procedure for the PAL (authentication protocol for the PAL). This first access authentication system is an operation form that is mainly applicable to a case where the MH newly requires PAL and SAL connection authentication (newly issues PAL and SAL registration requests) at the time of power-on of the MH or the like.

By the way, a case is assumable in which the validity periods of authentication sessions vary from access line to access line. For instance, there is a case where the validity period of the authentication session for the PAL is 10 minutes but the validity period of the authentication session for the SAL is five minutes. That is, there is a case where the validity period of the authentication session for the SAL is shorter than the validity period of the authentication session for the PAL. In this case, after the authentication of the PAL and the authentication of the SAL are performed substantially at the same time using the first access authentication system, when the next PAL and SAL authentication request messages are sent out using the first access authentication system, there is a possibility that the validity period of the SAL authentication session may have expired and communication using the SAL may become impossible before the next authentication request messages are sent out.

In order to avoid the problem described above, the MH generates the next SAL authentication request message and sends it out independently of the sending out processing of the next PAL authentication request message. The authentication of the SAL is performed using the PAL authentication procedure like in the first system.

When the MH is capable of using both the PAL and the SAL, it is possible to realize the second system with the following functions.

As capability on the MH side (user side), the MH has an authentication request message sending out function and an authentication response message processing function. The authentication request message sending out function in the second system is a PAL protocol control function that is capable of sending out a message (hereinafter referred to as the “unique message”) that is different from the PAL authentication request message containing authentication information (held in the MH) concerning the PAL as well as each other co-existing SAL in accordance with the PAL authentication procedure.

The authentication response message processing function is a PAL authentication protocol control function that is capable of receiving a message containing a SAL authentication response with respect to the unique message in accordance with the PAL authentication procedure, extracting information (packet encryption key, for instance) concerning the use of the SAL contained in the received message, and holding (caching) the extracted information in the MH.

On the other hand, the following functions are provided as capability on the network side.

A function of performing authentication processing using SAL authentication information contained in the unique message received from the MH with an authentication protocol control function possessed by the AAA and, when a result of the authentication is positive, transmitting an authentication confirmation message containing authentication information (use permission information) for the SAL to the MH in accordance with the PAL authentication procedure.

A function of enabling access by the authenticated MH to the access point AP (AP-2) accommodating the SAL.

The second access authentication system will be described with reference to FIG. 5.

When the MH detects that the MH itself is capable of connecting to the SAL, it transmits an authentication request message (unique message) containing authentication information for the SAL to the AAA/ACS using the PAL authentication protocol control function ((1) in FIG. 5).

The AAA/ACS receives the unique message from the MH and performs an SAL authentication operation. Through this operation, the AAA/ACS detects that the MH is also capable of accessing the SAL ((2) in FIG. 5).

When a result of the authentication of the SAL is positive, the AAA/ACS transmits a message ordering to permit access by the MH to the access point AP-2 of the SAL via the EN-2 ((3) in FIG. 5).

The AAA/ACS informs that the authentication of the SAL has been performed via the PAL ((4) in FIG. 5). After this, the MH is capable of performing communication using the SAL ((5) in FIG. 5).

FIG. 8 shows an example of an authentication request packet (unique message) used in the second system. In FIG. 8, an access point number that is a number identifying the AP of the SAL that is the authentication target of the subscriber is described as the authentication information for the SAL in addition to user identification information (not shown). Also, an address for the SAL is described which is an address (c/o address in the case of mobile IP, for instance) equivalent to the destination address of a packet via the SAL.

On the other hand, in the case of information identifying an ordinary PAL (public switched telephone network (PSTN), for instance), a personal identification number (PIN) (numerical string for personal authentication), an NAI, or the like is described as identification information for the PAL.

It should be noted that in the second system, it is sufficient that the authentication information for the SAL is described in the format of the authentication message for the PAL. Therefore, the type of the PAL does not matter.

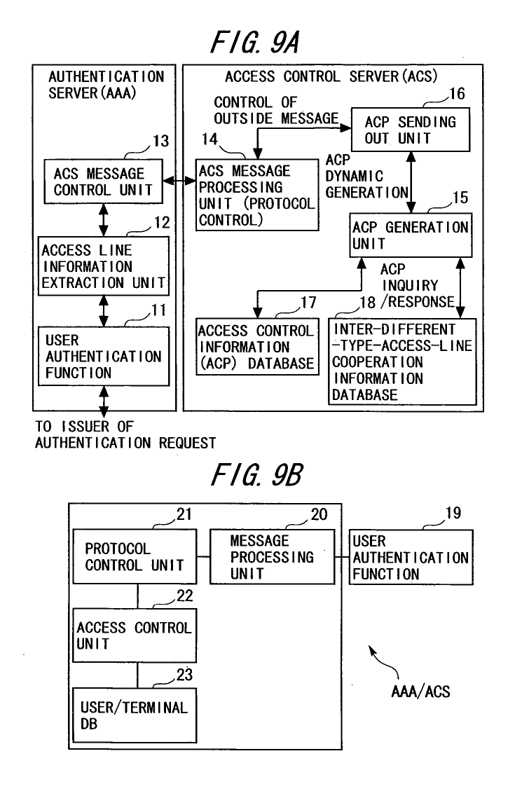

With the second system, even when the validity period of the authentication session for the PAL and the validity period of the authentication session for the SAL are different from each other, it becomes possible to continue the use of the SAL by updating the authentication session for the SAL independently of the authentication cycles for the PAL.

<5> Authentication Server and Access Control Server (FIGS. 9, 10, and 11)

Next, cooperation between multiple access lines achieved by the authentication server (AAA), the access control apparatus (access control server (ACS)), and cooperation between the AAA and the ACS will be described.

When a certain condition concerning the MH and the access line that the MH is currently using is satisfied at the existing position of the user (MH) the AAA and the ACS recognize a relation with an access line, to which it is possible to transit, and start transition between the access lines. More specifically, when a transition condition is satisfied, the AAA and the ACS automatically generate an access control profile (ACP-V) concerning the MH and distributes the generated ACP-V to the EN accommodating the transition destination access line on the CN side.

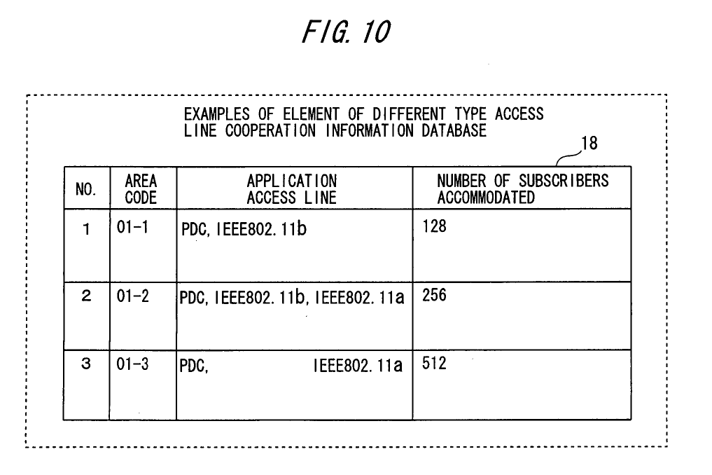

FIGS. 9A and 9B are functional block diagrams showing examples of configurations of the authentication server AAA and the access control server ACS, and FIG. 10 is a table showing an example of contents of an inter-different-type-access-line cooperation information database.

As shown in FIG. 9A, the AAA includes, as an authentication server function, a user authentication function (user authentication unit) 11, an access line information extraction unit 12, and an ACS message control unit 13. The user authentication function 11 serves as a general function (user authentication function) of the authentication server. The access line information extraction unit 12 extracts information relating to an access line that is an authentication target (containing access line information, subscriber identification information, access line type, MH existing position (area code), and the like) contained in a PAL authentication request message (or a unique message). The ACS message control unit 13 generates a message (ACS request message) for notifying the access control server (ACS) of the extracted access line information and sends out the message toward the ACS. Also, the ACS message control unit 13 receives an ACS response message from the ACS.

On the other hand, the ACS includes, as an access control server function, an ACS message processing unit (protocol control) 14, an access control profile (ACP) generation unit 15, an access control profile (ACP) sending out unit 16, an access control information database (ACP-DB) 17, and an inter-different-type-access-line cooperation information database 18.

The ACS message processing unit 14 performs message and protocol control for ACP request message reception and ACP response message transmission with respect to the AAA. The ACP generation unit 15 determines a currently usable condition for the access type whose use (authentication) is requested by the MH. The ACP sending out unit 16 performs message conversion of ACP (generation of ACP). The ACP-DB 17 is a database function of storing and managing ACPs on an MH basis. The inter-different-type-access-line cooperation information database 18 manages information sets concerning access lines usable in a unit area of a management target defined by the carrier as a database.

As shown in FIG. 10, the different type access line cooperation information database 18 is, for instance, composed of one or more records, each of which corresponds to an area code and includes elements that are a PAL area code, an application access line showing each other access line that is usable in an area having the area code, and the number of subscribers accommodated in the area.

It should be noted that it is possible to realize the functions of the AAA and the ACS shown in FIG. 9A using the configuration example shown in FIG. 9B. FIG. 9B shows an access control apparatus (AAA/ACS) having the functions of the AAA and the ACS. In FIG. 9B, the AAA/ACS is specified as an apparatus including a user authentication function 19, a message processing unit 20, a protocol control unit 21, an access control unit 22, and a user/terminal database 23.

The message processing unit 20 corresponds to the ACS message processing unit 14 and the ACP sending out unit 16 shown in FIG. 9A. Also, the protocol control unit 21 and the access control unit 22 correspond to the ACP generation unit 15 and the ACP sending out unit 16 shown in FIG. 9A. Further, the user/terminal database 23 corresponds to the ACP-DB 17 and the inter-different-type-access-line cooperation information database 18 shown in FIG. 9A.

Next, an example of an operation of the AAA and the ACS will be described on the assumption that the PAL is the third generation mobile telephone network (e.g., W-CDMA network), the SAL is an IEEE802.11b network, and the user has moved from a region where access to the PAL is possible to a region where access to both the PAL and the SAL is possible.

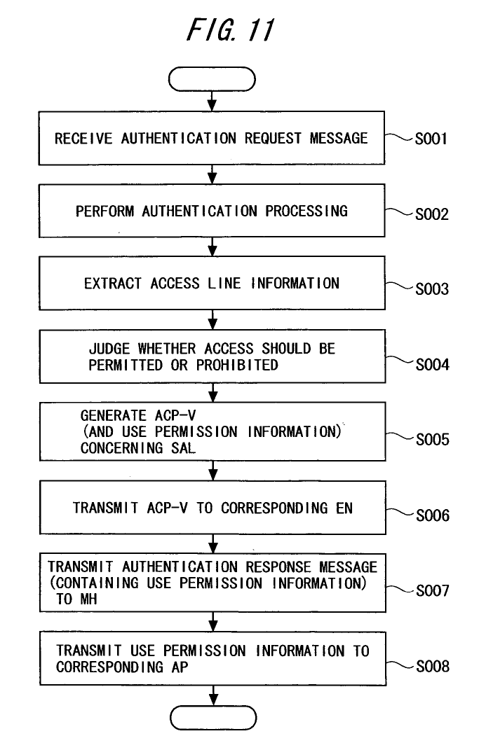

FIG. 11 is a flowchart showing processing of the AAA and the ACS. In FIG. 11, first, the AAA receives an authentication request message (containing authentication information for the SAL) from the MH (step S001). In response to this message, the user authentication unit of the AAA extracts the authentication information from the authentication request message and performs authentication processing (S002). Also, the access line information extraction unit extracts access line information of an authentication target from the authentication request message (S003). Then, the ACS message control unit generates an ACS request message containing the extracted access line information and transmits the generated message to the ACS.

The ACS request message is received by the ACS message processing unit of the ACS and is passed to the ACP generation unit. The ACP generation unit refers to the ACP-DB and the inter-different-type-access-line cooperation information database using the access line information contained in the ACS request message and judges whether it is possible or not for the user to access the SAL (SAL use permission/prohibition) based on a predetermined condition such as the existing position of the user and a use condition under a subscribing contract of the user (ACP definition contents) (S004).

When the ACP generation unit has judged that it is possible to permit the MH to use the SAL, the ACP sending out unit generates an ACP-V for each of the PAL and the SAL (S005) and generates an ACS response message containing the generated ACP-V. At this time, criteria for access line selection corresponding to the service contents defined in the ACP-V may also be described in the ACP-V. The ACS response message is transmitted from the ACS message processing unit to the AAA.

After the ACS message control unit of the AAA receives the ACS response message, the access line information extraction unit extracts each ACP-V contained in the response message. The AAA transmits the extracted ACP-V to its corresponding EN (S006). Also, the user authentication function transmits an authentication response message containing use permission information for the PAL and the SAL to the MH via the PAL (S007). Also, the AAA transmits messages containing information for permitting the MH to use the PAL and the SAL to their corresponding APs (S008).

It should be noted that in the processing described above, the transmission processing of the ACP-V to the EN and the transmission processing of the use permission information to the AP may be performed on the ACS side. Also, the AAA may perform the authentication processing only for each access network (access line) whose access is permitted at the ACS. Further, when it is judged at the ACS that the access is impossible, the AAA may transmit an authentication rejection message as to the access line to the MH.

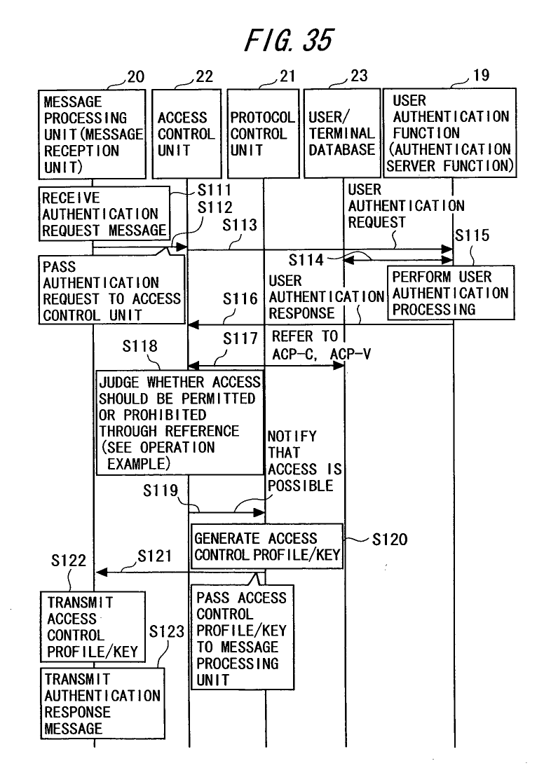

FIG. 35 is a sequence diagram showing an operation of the access control apparatus (AAA/ACS) having the configuration shown in FIG. 9B.

In FIG. 35, first, the message processing unit (message reception unit) 20 receives an authentication request message (see FIG. 7) from the MH (S111). Then, the message processing unit 111 passes the authentication request message to the access control unit 22 (S112).

Then, the access control unit 22 passes the authentication request message to the user authentication function (authentication server function) 19 (S113). Then, the user authentication function 19 refers to the user/terminal database 23 (S114) and performs user authentication processing (S115). The user authentication function 19 returns a result of the user authentication processing to the access control unit 22 as a user authentication response (S116).

Then, the access control unit 22 refers to the ACP (ACP-C, ACP-V) concerning the user, who issued the authentication request message, held in the user/terminal database 23 (S117). Then, the access control unit 22 judges whether access to the access line by the user should be permitted or prohibited (S118).

When it is possible to permit the user to use the access line, the access control unit 22 notifies the protocol control unit 21 that the use of the access line by the user is possible (S119). Then, the protocol control unit 21 generates an access control profile (ACP-V) that should be sent to a corresponding EN and a (packet) encryption/decryption key to be used at the time of the use of the access line (S120). Then, the protocol control unit 21 passes the generated ACP-V and encryption/decryption key to the message processing unit 20 (S121).

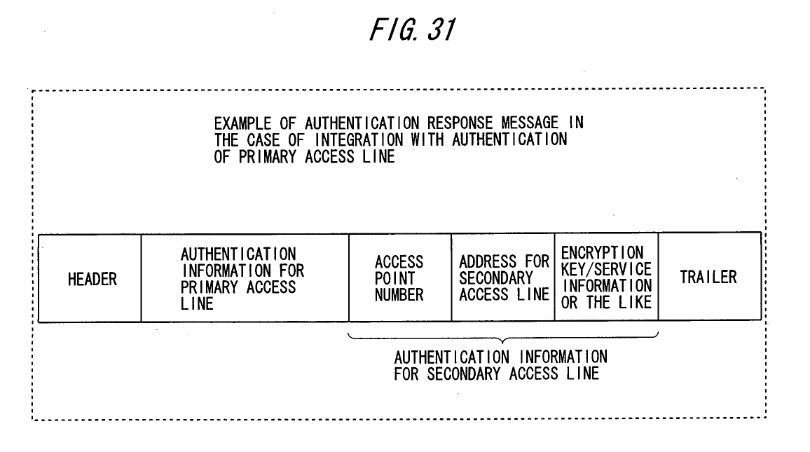

Then, the message processing unit 20 transmits the ACP-V and the encryption/decryption key to the EN accommodating the access line whose use has been permitted (S122). Following this, the message processing unit 20 generates an authentication response message containing the encryption/decryption key (see FIG. 31) and transmits the generated message to the terminal (MH) of the user (S123). The authentication response message arrives at the MH via the primary access line (PAL).

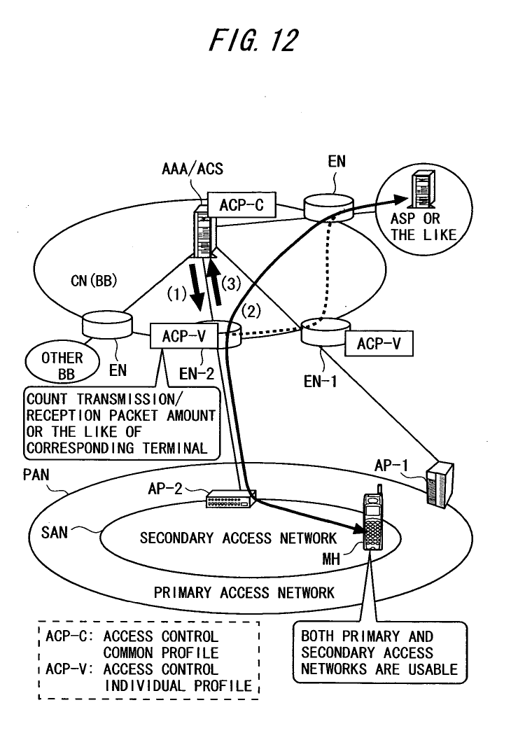

The details of S117 to S123 in the procedure described above (example of the line selection procedure) will be described below.

<Procedure 1> In S118, the access control unit 22 refers to the “subscriber identification information” having an item number “1” of the ACP-C (see FIG. 3) in the database 23 and confirms that the ACP-C is the profile of the user (terminal) that issued the authentication request message.

<Procedure 2> When the confirmation in procedure 1 in S118 has ended normally (when the identification information of the profile and the identification information of the terminal agree with each other), the access control unit 22 refers to the “usable access line” having an item number “2” of the ACP-C. In this example, for instance, it is assumed that it has been recognized that it is possible to use a “personal handy phone system (PHS)” as the primary access line and it is possible to use a “public wireless LAN” as the secondary access line.

<Procedure 3> In S118, the access control unit 22 next refers to the “selection priority order” having an item number “3” of the ACP-C and recognizes the connection priorities set for the lines by the user under a contract. For instance, the public wireless LAN is set as the first candidate and the PHS is set as the second candidate. Note that for the final determination of a line that the user is permitted to connect to (use), it is necessary for the network administrator to confirm in advance that there exist any free access lines of the public wireless LAN.

<Procedure 4> When a condition for judging that it is possible for the user to receive the provision (use) of the public wireless LAN is satisfied in procedure 3, for instance, the packet encryption/decryption key for the wireless LAN is distributed from the network side to the user, thereby permitting access (S119 to S123). At this time, in S120, a time, at which a predetermined access validity period from the point in time of the permission expires, is set in the profile (ACP-V).

<6> Sharing of Charging (Billing) Target Information Collection Function (FIG. 12)

Next, a method (SAL volume-based billing method) for charging with respect to the use amount of an access line (public wireless LAN service, for instance) that the carrier introduces as an SAL will be described.

As a charging method other than a flat-rate system, it is possible to perform measured charging where a predetermined measurement unit (access authentication time, packet transmission and reception amount, or the like) is measured and charging is performed in accordance with the authentication time or the packet amount. At this time, a dedicated charging mechanism is not prepared for each SAL and a charging system that the carrier has already constructed for the PAL is used for SAL charging. With this configuration, the introduction of a new access network to the CN is facilitated and it becomes possible to achieve a reduction in operation cost.

In this embodiment, sharing charging information for the PAL and the SAL is shared by adding the following functions to the network side. That is, the AAA functions as an authentication server and a charging server and has a function of, at the time of authentication of the SAL, transmitting the identification information of the MH and a charging condition to the EN accommodating the SAL. For instance, the charging condition includes a charging target, a charging unit, and a charging unit price.

In the charging condition, for instance, packet communication by the MH using the SAL is designated as the charging target, a packet transmission and reception amount is designated as the charging unit, and a charge per unit packet amount is designated as the charging unit price. The EN is informed of at least the charging unit in the charging condition. Note that it is also possible to designate packets based on a specific protocol as the charging target.

On the other hand, the EN accommodating the SAL has a function of measuring an amount (packet transmission and reception amount, for instance) corresponding to the charging unit based on the MH identification information and the charging condition (at least the charging unit) received from the AAA. In addition, the EN accommodating the SAL has a function of periodically transmitting the measured amount corresponding to the charging unit to the AAA as charging information.

FIG. 12 shows an example of an operation relating to the SAL measured charging. The operation example shown in FIG. 12 will be described below.

At the time of authentication of the SAL, the AAA transmits the MH identification information and information showing the charging unit (packet transmission and reception amount) to the EN (EN-2) accommodating the SAL ((1) in FIG. 12). It is possible to insert these information into the ACP-V (see “6. Charging Condition” in FIG. 4B).

After that, when the MH performs packet communication using the SAL, the EN-2 identifies the MH using the MH identification information received from the AAA and measures a packet transmission and reception amount in the packet communication by the MH based on the information of the charging unit relating to the MH ((2) in FIG. 12). In this manner, the edge router counts an amount based on the charging unit such as the packet transmission and reception amount. It is possible to determine a condition for the packet counting with reference to the contents set by the ACP-V.

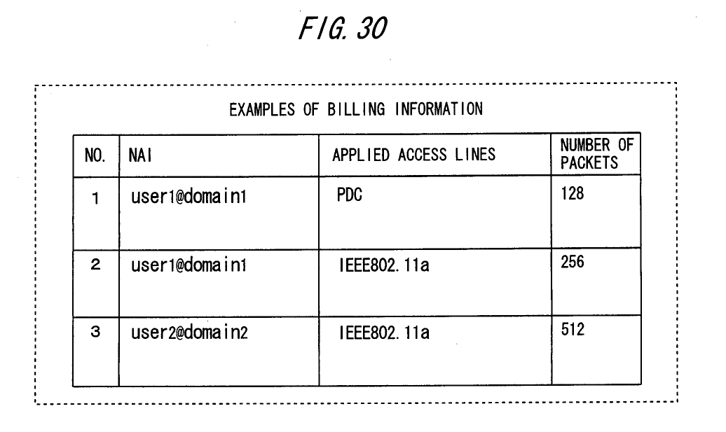

Then, the EN-2 periodically transmits charging information containing the packet transmission and reception amount (measured packet transmission and reception amount) to the AAA ((3) in FIG. 12). An example of the charging information transmitted to the AAA is shown in FIG. 30. As shown in FIG. 30, the charging information includes records that are each composed of user identification information (NAI, for instance), the type of an application access line, and a packet transmission and reception amount (number of packets, for instance).

The AAA holds information of the charging condition (charging target, charging unit, and charging unit price) for the MH and, when receiving the charging information from the EN-2, calculates a charge relating to the use of the SAL by the MH using the information of the charging unit price. In the example shown in FIG. 30, the AAA calculates a charging amount by multiplying the charging unit price by the number of packets.

In this manner, the already-existing charging system (AAA and EN) prepared for the PAL performs charging processing with respect to the use of the access line defined as the SAL. Accordingly, there is no necessity to prepare in advance a charging system for the SAL independently of the charging system for the PAL.

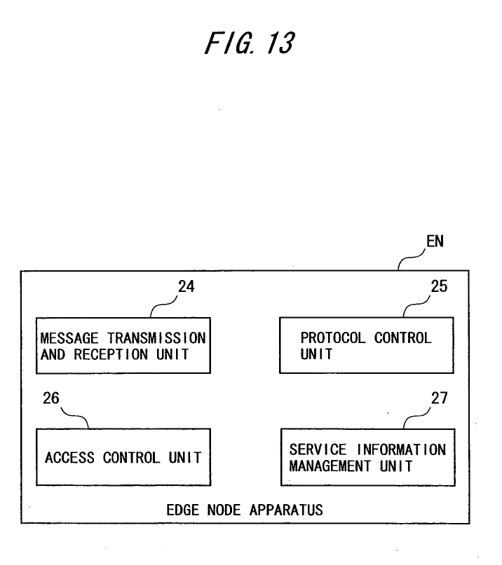

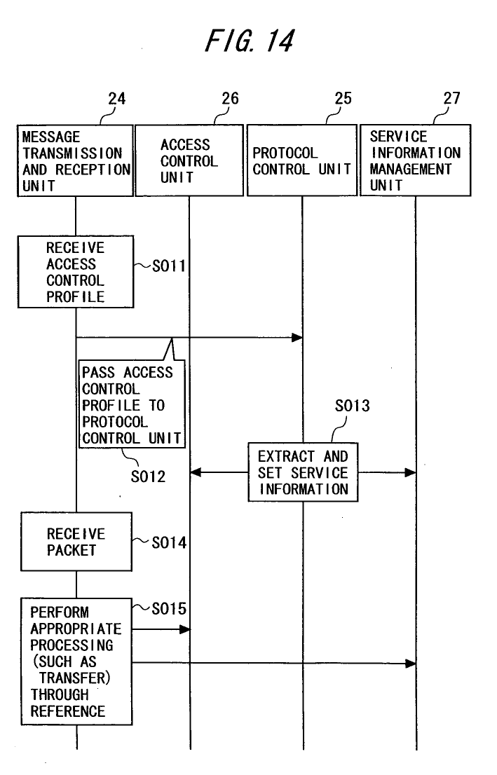

It should be noted that as described above, the identification information and charging condition transmission processing may be performed through transmission by the AAA of the ACP-V for the SAL corresponding to the user of the MH containing the identification information and the charging condition to the EN-2.

<7> Edge Node Apparatus (FIGS. 13 and 14)

Next, the edge node apparatus (EN) will be described. The edge node apparatus is disposed in an edge portion of the CN and performs access control on an MH basis in addition to a general routing function. At least one edge node apparatus is disposed for each access line type. Note that the edge node apparatus may be disposed in units of subscriber regions defined in terms of geography or an accommodation population density.

The edge node apparatus mainly includes an edge router function, an access control profile transmission message protocol control function (ACS transmission message control function), an access control profile holding and storing function (ACS holding and storing function), an access authentication information management function, an access filter function, and an individual condition packet transfer function.

The edge node function serves as a function of achieving general operations (such as routing and forwarding of packets) of a router.

The ACS transmission message protocol control function is a function of controlling processing relating to a message (ACS transmission message) containing the ACS of the MH transmitted from the ACS or the AAA. More specifically, the ACS transmission message protocol control function receives the ACS transmission message, analyzes the received message, and extracts the ACS.

The ACS holding and storing function is storing means and a management function of holding the ACS extracted by the ACS transmission message protocol control function in the EN only for a given validity period. For instance, the ACS management function manages the ACS in accordance with a condition, such as a validity period, (deletes the ACS when its validity period has expired, for instance).

The access authentication information management function is a function of managing the permission/prohibition of access by the MH based on authentication information (such as a result of authentication) transmitted from the AAA.

The access filter function is a function that cooperates with the access authentication information management function and, when the access by the MH is prohibited, abandons (discards) each packet relating to the MH.

The individual condition packet transfer function is a function of transferring each packet of the MH to a predetermined destination in accordance with a packet transfer condition (transition condition) described in the ACS in cooperation with the ACS holding and storing function.

FIG. 13 shows an example of a configuration of the edge node apparatus. In FIG. 13, the edge node apparatus (EN) includes a message transmission and reception unit 24, a protocol control unit 25, an access control unit 26, and a service information management unit 27. It is possible to realize these units through execution of predetermined programs by a processor (including a memory) incorporated into the edge node apparatus.

The message transmission and reception unit 24 realizes the edge node function. The message transmission and reception unit 24 also achieves the individual condition packet transfer function based on information from the service information management unit 27. The protocol control unit 25 realizes the ACS transmission message protocol control function. The access control unit 26 realizes the access filter function. The service information management unit 27 realizes the ACS holding and storing function and the access authentication information management function.

FIG. 14 is a sequence diagram showing ACS reception processing at the edge node apparatus having the configuration shown in FIG. 13. An example of an operation of the edge node apparatus in the case where the user of the MH has moved from a region where it is possible to access the PAL (W-CDMA network, for instance) to a region where it is possible to access both the PAL and the SAL (IEEE802.11b network, for instance) will be described using FIG. 14.

The MH performs an authentication procedure for the PAL and the SAL and receives authentication permission as to both the PAL and the SAL. Then, the AAA or the ACS transmits a message (ACP transmission message) containing the ACP (ACP-V) corresponding to the MH and the access line type to each of the edge node apparatuses that respectively accommodate the PAL and the SAL.

At each of the edge node apparatuses respectively accommodating the PAL and the SAL, the message transmission and reception unit 24 receives the ACP transmission message (S011) and passes the received message to the protocol control unit 25 (S012). The protocol control unit 25 analyzes the message, extracts the ACP-V from the message, and sets the contents of access control (service information) described in the ACP-V in the access control unit 26 and the service information management unit 27 (S013) For instance, when the access control contents designate transfer of a packet addressed to the MH and received by the EN of the PAL to the EN of the SAL, the protocol control unit 25 makes a setting for the transfer in the access control unit 26 and the service information management unit 27.

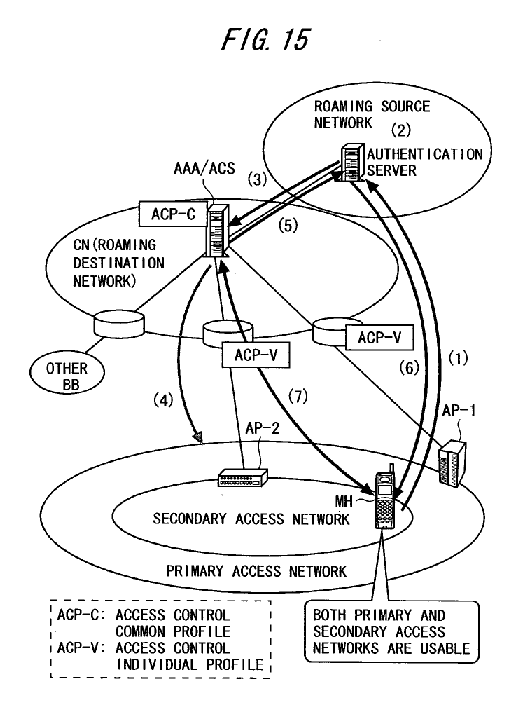

Following this, the message transmission and reception unit 24 receives a packet addressed to the MH (S014) and performs appropriate processing with reference to the access control contents set in the access control unit 26 and/or the service information management unit 27 (S015). For instance, when the EN of the PAL has received the packet addressed to the MH, the message transmission and reception unit 24 refers to the access control contents set in the access control unit 26 and the service information managed by the service information management unit 27 and transfers the packet to the EN of the SAL based on these information. Then, the EN of the SAL transfers the packet to the MH via the SAL. Also, depending on the access control contents set in the ENs of the PAL and the SAL, it is possible to perform control where, for instance, communication is performed via the PAL at the time of password input and other packets are transferred from the EN of the PAL to the EN of the SAL.

<8> Access Control with Respect to Roaming from Another Network Provider (FIG. 15)

There is a case where, as a roaming user, a user, who uses a wireless host of another provider under a contract, is permitted to use the access line of the own network having compatibility as to wireless communication system. In an access authentication system in this case, access authentication of the roaming mobile host is transferred from the other carrier network to the authentication apparatus in the own carrier network and a temporary access control profile dedicated to the roaming user is issued, thereby temporarily permitting the use of the access line of the own network.

When the MH is capable of using both the PAL and the SAL, the authentication system in this section of this specification is achieved with the following functions.

The MH has the following functions (capability).

A function (PAL protocol control function) of sending out authentication information (held in the MH) concerning each other coexisting SAL as well as the PAL.

A function (PAL authentication protocol control function) of receiving an authentication response message for the SAL, extracting information (packet encryption key, for instance) concerning the use of the SAL contained in the received message, and holding (caching) the extracted information in the MH.

The network-side (roaming source) has the following functions (capabilities).

A function of performing authentication using an SAL authentication request message received by the “authentication protocol control function” of the AAA and transmitting an authentication result for the SAL to a roaming destination. A function of transferring an access permission notification for the MH received from the roaming source to the MH.

Also, the network-side (roaming destination) has a function (capability) of, based on the authentication result for the SAL received from the roaming source, making a setting so that the authenticated MH is capable of using the AP accommodating the SAL.

FIG. 15 shows an example of an operation of access control with respect to roaming from another NOP. The operation example shown in FIG. 15 will be described below.

The MH is the MH of a user holding a subscribing contract for the use of the network of another carrier (roaming source network). When detecting with an already-existing technique that connection to the SAL is possible at a place where the use of the PAL and the SAL is possible through roaming, the MH transmits an authentication request message for the SAL to an authentication server in the roaming source network via the PAL ((1) in FIG. 5). At this time, to the authentication request message, it is possible to apply the formats of the authentication messages (see FIGS. 7 and 8) used with the first and second techniques described above.

At the time of authentication with respect to the authentication request for the SAL, the authentication server of the roaming source detects that the MH is also capable of accessing the SAL ((2) in FIG. 15).

The authentication server of the roaming source transmits an authentication completion message to the authentication server (AAA) in the network (CN) of the roaming destination ((3) in FIG. 15). Note that to a message ordering (requesting) access permission, it is possible to apply the message format shown in FIG. 31. There is also a case where an encryption/decryption key used between the terminal and the access point or the like is contained in the message.

The AAA of the roaming destination transmits a message ordering to permit access by the MH to the EN and the AP accommodating the SAL ((4) in FIG. 15).

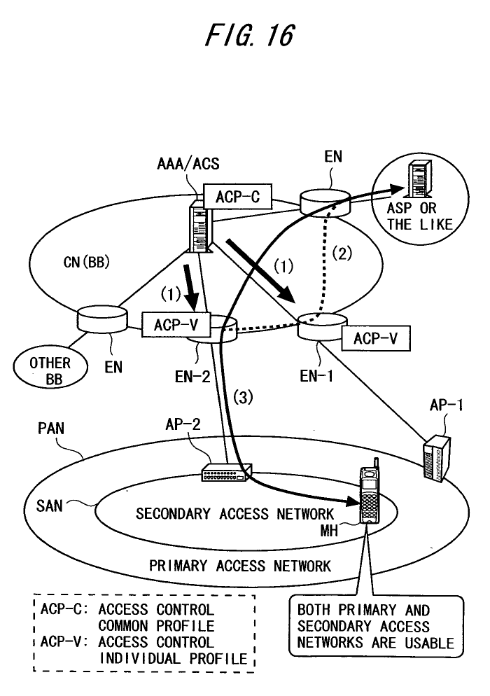

The AAA of the roaming destination informs the authentication server of the roaming source that authentication of the SAL has been performed ((5) in FIG. 15) and the authentication server of the roaming source informs the MH that the authentication of the SAL has been performed via the PAL through transmission of an authentication response message ((6) in FIG. 15). After this, the MH is capable of performing communication using the SAL ((7) in FIG. 15).

<9> Access Line Selection Basic System (FIG. 16)

The network access control system performs an assessment and permission operation as to a connection destination access line at the authentication/service control apparatus with reference to the contents of the access control profile concerning an authentication target user and a network state and informs the user of a result of this operation. More specifically, the network access control system selects an access line, to which connection should be established, based on a cooperation priority order of multiple access lines (variable depending on time, place, or the like).

In this section of this specification, a basic procedure of access line selection at the access control server (ACS) will be described. The ACS is a part of the authentication server or is an apparatus that cooperates with the authentication server and has a function of selecting an access line that should be allocated to the user (MH).

An access line selection logic executed at the ACS will be described.

(9-1) At the Time of Initial Registration

This case corresponds to a case where at the point in time when the MH sends out an authentication request message (at the point in time of mobile host registration request sending out), no authentication session exists (last authentication session is completed).

1. When the authentication of the user (MH) by the AAA has completed normally, the AAA transmits an access line selection request (ACS request message) to the ACS.

2. The ACS refers to the ACP concerning the user extracted from the ACP-DB through the authentication procedure for the MH.

3. At this time, as an optional function, it is possible to use a communication state (network state) as a parameter of the access line selection logic at the ACS by also transmitting, to the ACS, a communication state (communication parameter), such as a reception radio wave strength of the MH, transmitted from the MH through the authentication procedure.

4. The ACS selects a transition destination access line based on the ACP (and the communication parameter).

5. When the communication parameter is used as a parameter of the selection logic, the ACS first determines the transition destination access line and next refers to the communication parameter as necessary.

6. The ACS generates an access control individual profile (ACP-V) containing this communication parameter for the selected transition destination access line.

7. The generated ACP-V is transmitted to its corresponding edge node (EN) by means of a profile transmission message and is used for access control.

8. When the selected line is the SAL, the ACS transmits a corresponding ACP-V also to the EN accommodating the PAL. However, the control state (operation state) in this ACP-V is set at a “blockage state” indicating that the EN of the PAL is not provided for data transfer by the MH at this point in time.

9. In addition, the ACS distributes the ACP-V to the EN accommodating the transition source access line by means of a profile transmission message. However, the “operation state” of the ACP-V transmitted to the transition source is set at a “transfer (forwarding)” state. Through this setting, each packet addressed to the mobile host and received by the edge node before the transition is transferred to the transition destination edge node and is transmitted to the mobile host that is currently accommodated in the transition destination access line.

(9-2) At the Time of Line Transition

This case corresponds to a case where an authentication session, whose validity period has not yet expired, exists in the MH and the MH is already using any access line.

1. The ACS in the CN detects (selects) a transition destination access line for the MH under a certain condition. This operation is realized by a periodical monitoring program in the ACS. At this point in time, however, the ACS does not grasp the latest state of the MH, so the ACS detects the transition destination access line merely as a transition destination candidate.

2. After determining the transition destination access line candidate, the ACS waits for arrival of the next authentication request message among authentication request messages periodically transmitted from the MH.

3. When the MH sends out a periodical authentication message, the communication states (such as the reception radio wave strengths) of both the PAL and the SAL concerning the MH at this time moment are inserted into the authentication request message as parameters and arrive at the AAA.

4. The AAA extracts the communication state parameters of the MH and transmits the extracted parameters to the ACS.

5. On receiving the communication state parameters of the MH, the ACS judges whether the transition destination candidate detected in advance is usable with reference to the communication state parameters. When transition is possible (for instance, the area code of the selected transition destination access line and the existing information of the MH agree with each other), the AAA adds an access line transition instruction (containing a transition destination access line type) into an authentication response message and transmits the message to the MH.

6. On receiving the authentication response message with respect to the periodical registration, the MH recognizes that access line transition has been instructed. Therefore, the protocol control function in the MH switches its valid access line to the transition destination access line indicated by the authentication response message. As a result, after this, communication using the transition destination access line becomes possible.

7. On the other hand, in the CN, with respect to each of the EN accommodating the transition destination access line selected by the ACS and the EN accommodating the transition source access line, a corresponding ACP-V is distributed by means of a profile transmission message. Here, the “operation state” of the ACP-V transmitted to the transition source EN is set at the “transfer (forwarding)” state. Through this setting, each packet addressed to the MH and received by the EN before the access line transition is transferred to the transition destination EN and is transmitted to the MH that is currently accommodated in the transition destination access line.

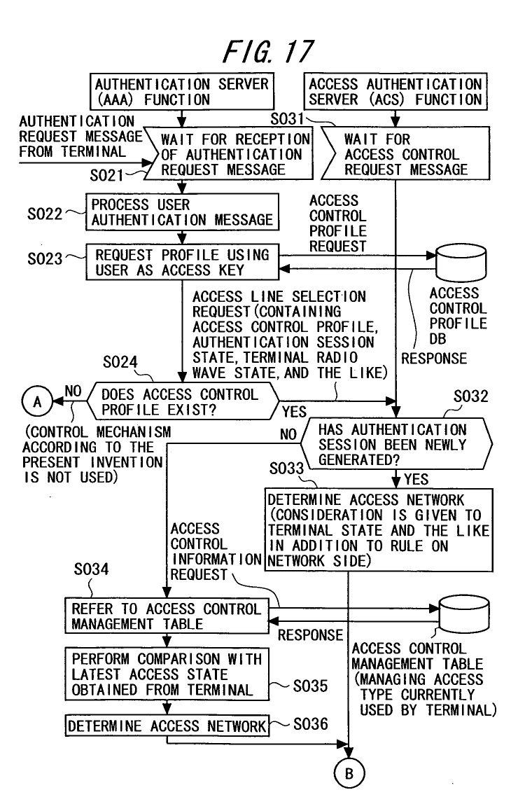

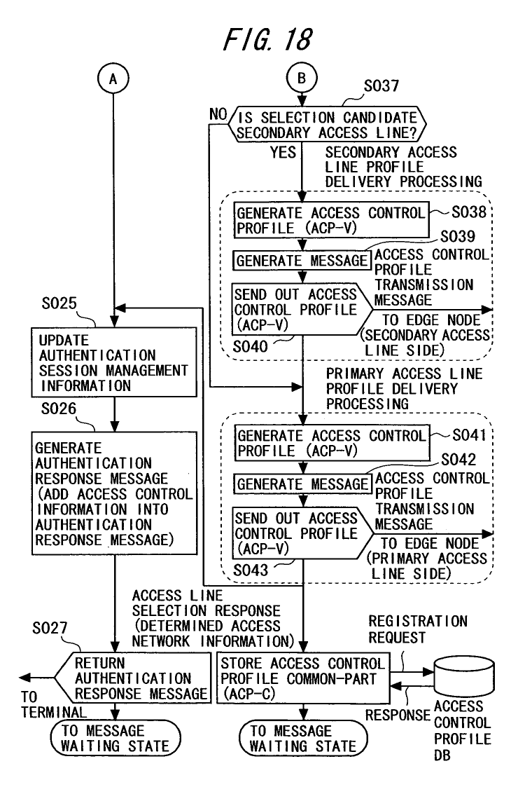

FIG. 16 shows an example of a control procedure in this section of this specification and FIGS. 17 and 18 are flowcharts showing an access network selection mechanism.

In FIGS. 17 and 18, the AAA receives an authentication request message from the MH (S021). Then, in order to determine an access network (access line type) whose use should be permitted, the AAA requests the ACS to perform access line type determination in course of ordinary authentication processing (user authentication message processing in S022).

More specifically, the AAA extracts the ACP-C prepared for each MH from the ACP-DB (S023). Following this, when the ACP-C is obtained (S024; YES), the AAA adds mobile host information (communication state parameter such as a radio wave state) contained in the authentication request message transmitted from the MH in the extracted ACP-C and notifies the ACS of the resultant. That is, the AAA gives the ACS an access line selection request containing the ACP-C, an authentication session state, the terminal radio wave state, and the like. Note that when no ACP-C exists (S024; NO), the processing proceeds to S025.

Following this, the AAA waits for a response from the ACS with respect to the access line selection request. On receiving a response message from the ACS, the AAA updates authentication session management information (S025) and generates an authentication response message (S026). That is, the AAA adds access network information (access control information showing the access network (access line type) allocated to the MH) contained in the response message into the authentication response message and delivers the message to the terminal (S027) Following this, the AAA returns to a message waiting state.

On the other hand, on receiving an access network determination request (access line selection request or access control request message) from the AAA, the ACS judges the presence or absence of an authentication session of the MH with reference to the communication state parameter contained in the request message (S032) Following this, when an authentication session (periodical update) exists (S032; NO), this means that the ACS has already generated access authentication information concerning the MH and holds it for the authentication session. Therefore, when the authentication session of the mobile host is valid, the ACS extracts the type of an access line currently used from the management table (access control management table) in the ACS (S034), performs a comparison with the latest mobile host state (access line currently used) (S035), and makes an access network determination (S036). Then, the AAA changes the access line type used if necessary.

On the other hand, when no authentication session exists (S032; YES), that is, when registration is performed for the first time, the ACS merely refers to the communication state parameter (such as the radio wave state) of the MH transmitted from the MH and makes an access line type (access network) selection or determination based on a determination rule described in the ACP-C transmitted from the AAA (S033).

After the access network determination, the ACS performs judgment processing in S037 and transmits control information (ACP-V) unique to a selected access network to the EN on a determined access network side based on a result of the judgment. That is, when a result of the judgment in S037 is negative (when the selected candidate is not a secondary access line), the ACS performs primary access line profile delivery processing. That is, the ACS generates an ACP-V corresponding to the PAL (S041), generates an access control profile transmission message (S042), and sends it out to a corresponding EN (S043). In contrast to this, when the selected access network is a SAN (SAL) (S037; YES), the ACS performs secondary access line profile delivery processing. That is, the ACS generates an ACP-V corresponding to the SAL (S038), generates an access control profile transmission message (S039), and sends it out to a corresponding EN (S040) In this case, following the above operations, the ACS performs the primary access line profile delivery processing (S041 to S043) and transmits an ACP-V also to the EN on a PAN (PAL) side. However, the operation state designated in this ACP-V is set at “line blockage (non-use)”.

After the processing in S043, the ACS returns an access line selection response (determined access network) to the AAA. Following this, the ACS stores an ACP-C in the ACP-DB and returns to a message waiting state.

It should be noted that instead of the operations shown in FIGS. 17 and 18, the ACP-Vs may be transmitted to their corresponding ENs via the AAA.

When the access line type that the MH uses transits from the PAL to the SAL, after the operations shown in FIGS. 17 and 18, operations shown in FIG. 16 are performed, for instance. That is, as shown in FIG. 16, after the authentication by the AAA is finished, the ACP-Vs are transmitted to the ENs corresponding to the PAL and the SAL, respectively ((1) in FIG. 16).

Then, one of the ENs respectively accommodating the PAL and the SAL receives a packet addressed to the MH and interprets an operation state corresponding to the packet by referring to the ACP-V. At this time, when the access line accommodated by the EN that received the packet is not an access line appropriate to transmission of the packet, the EN transfers the packet to the other of the ENs. The transfer destination EN transmits the packet received from the transfer source EN to the MH via the access line that it accommodates ((2) in FIG. 16).

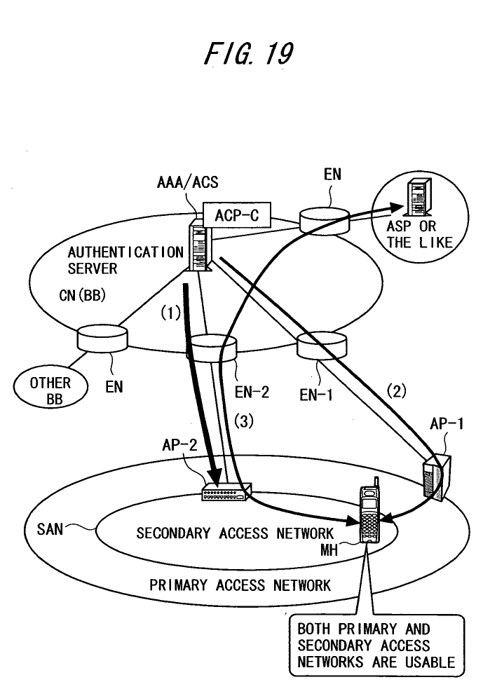

On the other hand, in accordance with a transition instruction contained in the authentication response message, the MH transmits a packet (packet addressed to a host accommodated in the BB of another carrier connected to the CN) to the CN via an access line corresponding to a transition destination ((3) in FIG. 16).

<10> Access Permission Procedure (FIG. 19)

Next, an access permission procedure in the network access control system will be described. After an access line type to be used for network connection of the MH is determined via an authentication and access line, the following means is used as means for permitting access by the MH.

When the ACP-V is transmitted to the EN accommodating the SAL, as to the access line that the EN accommodates, the EN permits data communication via the SAL based on authentication information exchanged between the MH and the network in advance through the authentication procedure for the PAL.

That is, the authentication information of the MH is transmitted to the EN accommodating the SAL based on the authentication information. This authentication information is contained in the ACP-V. On receiving the authentication information, the EN recognizes the contents of the ACP-V and performs an access permission operation for the MH. In the case of a wireless LAN access point, for instance, this permission procedure corresponds to an operation for registering the MAC address of the MH already registered.

On the MH side, the received authentication information is sent to the SAL protocol control apparatus. At the point in time when the authentication information is accepted, a state is obtained which is the same as a state where various authentication procedures as to an ordinary access line are completed.

The access permission procedure in this section of this specification requires the following functions and procedures. That is, the AAA has an authentication information generation function. The authentication information generation function is a function of, after the legitimacy of the MH is ensured for the SAL, generating SAL authentication information in the MH authentication procedure using the PAL.

Also, the ACS has an authentication information transmission function. This transmission function is a function of transmitting authentication information of the SAL, which the MH is to newly uses (to which the MH is to transit from the transit source), to the MH through an authentication procedure using the PAL (transmission of an authentication response message via the PAL).

Also, the MH has an authentication information extraction function. On receiving the authentication information, the MH extracts authentication information (packet encryption key, for instance) concerning the SAL from the authentication response message and informs the SAL protocol control function in the MH of the extracted information. On being informed of the authentication information, the SAL protocol control function in the MH saves the authentication information and uses it in data communication performed afterward.

Also, the EN has a function of removing an access limitation on the network side. On the network side, the authentication information generated by the ACS is distributed to the EN accommodating the SAL, using which the MH is to start communication, by means of an access control information transmission message (ACP-V transmission message). On receiving this message, the EN extracts the SAL authentication information contained in the message and holds the extracted information. In addition, the EN performs packet forwarding control based on the authentication information so that each packet sent out from the MH to the SAL passes through the EN.

FIG. 19 shows an example of an operation relating to the access permission procedure. The access permission procedure shown in FIG. 19 will be described below.

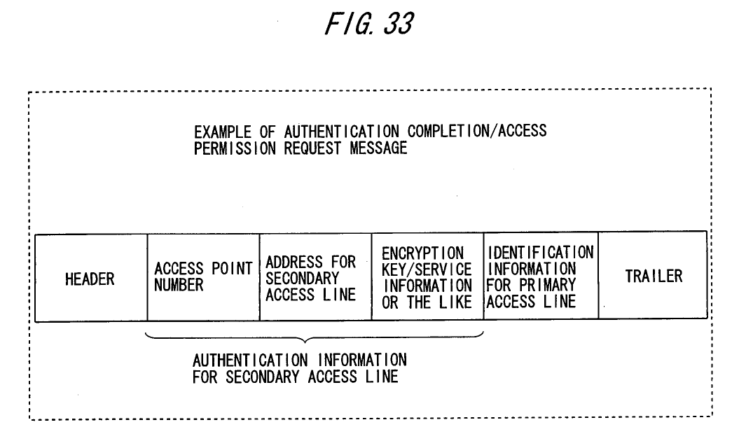

When it has been confirmed that the MH that is the authentication target has an SAL access right, the AAA transmits an authentication completion message (authentication confirmation message) to the AP accommodating the MH. In this authentication completion message, SAL use permission information (information of an encryption key between the MH and the AP or the like, for instance) is contained ((1) in FIG. 19). At this time, it is possible to use an authentication completion message having a format shown in FIG. 33.

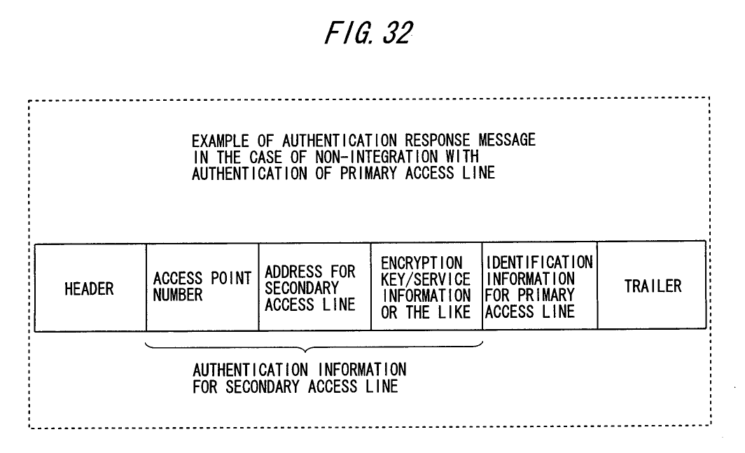

The AAA transmits an authentication confirmation (authentication response) message to the MH via the PAL. In this authentication confirmation message, SAL use permission information (information of an encryption key between the mobile host and the access point or the like, for instance) is contained ((2) in FIG. 19). At this time, it is possible to use an authentication response message having a format shown in FIG. 31 or 32.

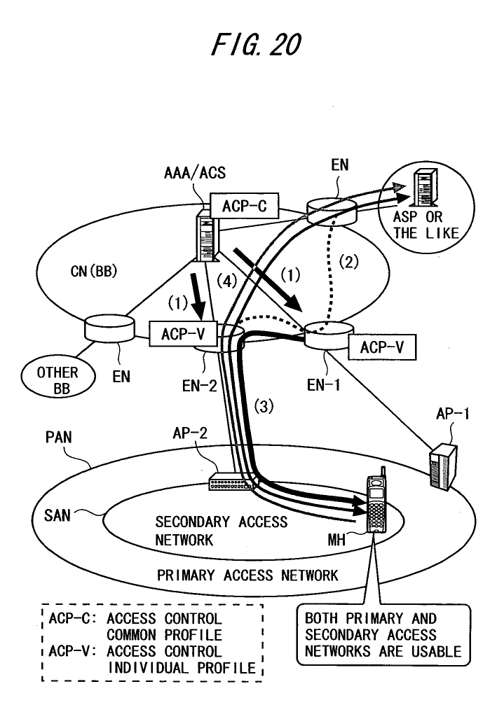

After this, the MH is capable of performing safe communication via the SAL using the use permission information (such as an encryption key) distributed to each of the MH and the AP ((3) in FIG. 19).

<11> Service Continuation Cooperation Between Access Lines of “Different Types” at the Time of Inter-Access-Line Movement (FIG. 20)

Next, a configuration in the network access control system for making it possible to detect a movement of the MH on the network side and to make a setting for connection to a movement destination will be described.

There is a case where at the time of transition of the MH between access lines of different types as a result of a judgment made by the ACS in the CN, there is a difference in characteristics (line speed, for instance) between the access network before the transition and the access network after the transition. For instance, a case is supposed in which an MH that uses public wireless LAN service goes out of a region where the public wireless LAN service is provided and enters into a region where only a PDC service is provided through a physical movement.

When such an inter-access-network movement has occurred, the ACS recognizes this situation and delivers an ACP-V containing contents for maintaining quality items having high priorities as much as possible to a transition destination EN by designating in advance priority items of quality contents as to the quality of an application that the MH used in an access network before transition.

For instance, a situation is assumed in which as a result of a movement of a user performing Web-browsing using a wireless LAN, a used access line has transited to a wireless access line adopting a different system and lowering of a communication speed is inevitable.

In such a case, for instance, there is a case where as a use requirement on the user side, the user wishes to maintain the same communication speed (response time) as before the transition (within the range of characteristic limitations of the line). That is, for instance, there is a method with which, in access to image data, a display size is not changed but the number of colors is reduced or a compression ratio is increased, thereby avoiding lowering of the response time. In addition, there is also a case where as the use condition on the user side, the user wishes to maintain the quality of contents obtained even when the response time is elongated.

Under such a use condition, in an access line switching procedure, the ACS finds differences between the transition destination access line type and the control contents of the current (transition source) access line, extracts items, to which the user has given high quality maintenance priorities (under a contract), from among the differences, generates an ACP-V concerning the transition destination line and having contents (parameters), with which it is possible to achieve quality maintenance of the items regardless of the line transition, and delivers the generated ACP-V to the EN accommodating the transition destination access line.

On receiving the ACP-V, the transition destination EN performs quality control for the MH having undergone the access line transition in accordance with the contents of the ACP-V, that is, based on the predetermined priority items and parameters described in the ACP-V.

FIG. 20 is an explanatory diagram of an example of an operation relating to a control procedure of service continuation cooperation between access lines. The operation example shown in FIG. 20 will be described below.

After authentication of a transition destination access line by the AAA is completed, the ACS transmits ACP-Vs (service information), in each of which the access control contents of the EN (old EN) accommodating a transition source access line or the access control contents of the EN (new EN) accommodating the transition destination access line are described, to these ENs ((1) in FIG. 20). At this time, the AAA is capable of transmitting an access permission request message having a format shown in FIG. 33 to each of the ENs.

When a packet addressed to the MH has arrived at the old EN, the old EN transfers the packet to the new EN in accordance with the contents of the ACP-V (service information) ((2) in FIG. 20).

When the service contents of the packet addressed to the MH differ from the contents described in the APC-V, the old EN notifies the MH of this situation ((3) in FIG. 20). At this time, it is possible for the old EN to issue a notification to the MH using a message format shown in FIG. 33.

The MH requests a correspondent node (CN) to make a setting change as to a transmission packet as necessary ((4) in FIG. 20). At this time, the MH transmits an application-dependent message to the correspondent node so that a request message corresponding to the protocol of an application (streaming, for instance) to be applied is transmitted thereto.

<12> Service Continuation Cooperation Between Access Lines of “Same Type” at the Time of Inter-Access-Line Movement

Next, a configuration of the network access control system for detecting a movement of the mobile host on the network side and making a setting for connection to a movement destination will be described.

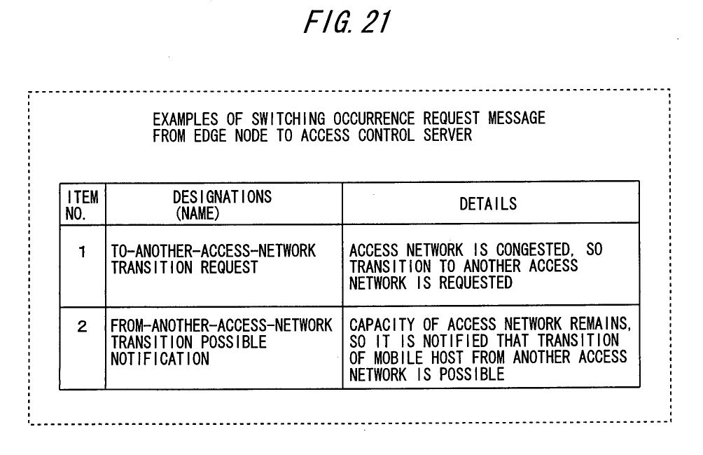

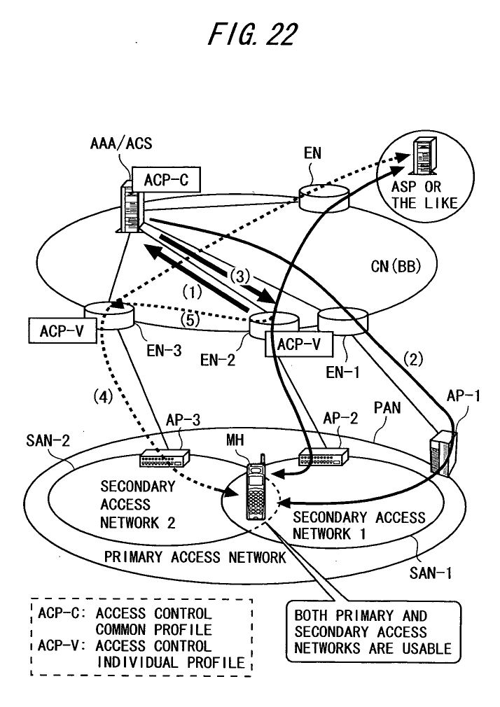

At the time of a movement of the MH between access lines of the same type, which are accommodated by different ENs, as a result of a judgment made by the ACS in the CN, the ACS in the CN distributes an ACP-V already generated for the MH to a transition destination EN. Through this operation, it becomes possible to deliver the ACP-V at high speed as compared with a case where the ACP-V is generated for the first time.

<13> Switching System 1 (Access Line Switching Due to Peripheral Network Resource State) (FIGS. 21 and 22)

Next, a configuration of the network access control system will be described with which, when the number of subscribers accommodated by an access line currently used approaches a number limit and performance degradation is expected to occur, it is possible to re-connect each subscriber meeting a certain contract condition to another access line having a sufficient remaining accommodation capacity.

The network access control system is capable of performing access line switching and transition based on a resource state that depends on a traffic state or the like in a network. For instance, there is a case where under a state where an MH is performing data communication using a PDC network as an access line, a voice circuit switched network in the PDC network is temporarily congested (due to a special event such as year-end). In such a case, generally, a regulation is applied to call origination on a switchboard side. In a like manner, each EN accommodating an access line monitors a traffic state and requests the ACS to start line transition for all or a part of MHs that it currently accommodates with a situation where an accommodation traffic condition exceeds a certain threshold value as a trigger.

On receiving this request, the ACS selects each MH, whose transition is possible, using line transition logic and performs access line switching for the MH.

FIG. 21 is a table showing examples of a switching occurrence request message. A message having an item number “1” in FIG. 21 is a request message transmitted from the EN to the ACS in order to request a movement to another access network and indicates that the access network that the EN accommodates is congested, so it is necessary to perform transition of the MH to another access network. On the other hand, a message having an item number “2” is a request message transmitted from the EN to the ACS in order to notify that a movement from another access network is possible and indicates that the access network (traffic that the EN accommodates) has a sufficient remaining capacity and therefore it is possible to perform transition of an MH accommodated in another access network to the own access network.

FIG. 22 shows an example of an operation relating to an access line switching control procedure in this section of this specification. The operation example shown in FIG. 22 will be described below.

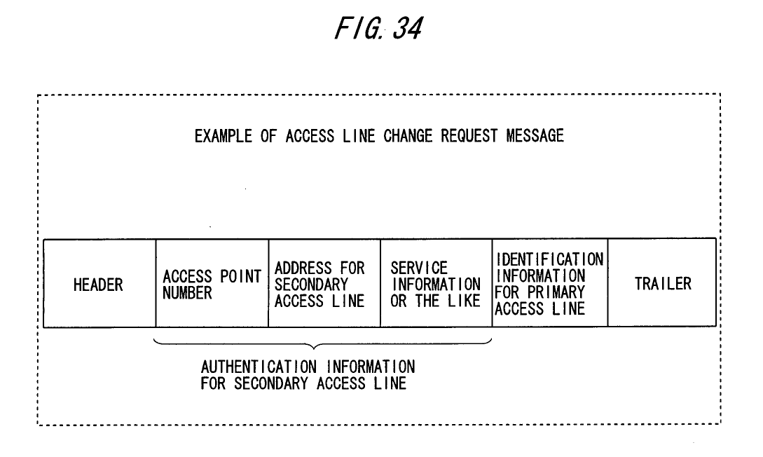

The EN (connected to the SAN) accommodating MHs via the SAL monitors the state of the SAL and, when the SAL state exceeds a certain threshold value (threshold value set for the number of MHs accommodated by the access line, for instance), notifies the AAA/ACS of this situation ((1) in FIG. 22). At this time, it is possible for the EN to be configured to transmit a message having a format shown in FIG. 34. Information showing that the threshold value has been exceeded is set in a field of service information or the like, for instance.

The AAA/ACS searches for an MH that is also accommodated in another EN (in the case shown in FIG. 22, the MH that is accommodated by the EN corresponding to the PAN) among the MHs that the EN accommodates, and informs the MH of access line switching ((2) in FIG. 22). At this time, it is possible to use a message shown in FIG. 33, for instance.

The AAA/ACS informs the EN accommodating the access line before switching (old EN: EN-2 in FIG. 22) of an ACP-V for transferring each packet addressed to the MH to the EN accommodating an access line after the switching (new EN: EN-3 in FIG. 22) ((3) in FIG. 22). At this time, it is possible to use a message shown in FIG. 33.

The MH performs access line switching. As an access line switching technique, it is possible to use the first system described above. In the example shown in FIG. 22, the MH switches from the SAL of the SAN-1 to the SAL of the SAN-2. After this, the MH uses the access line after the switching (SAL of the SAN-2) ((4) in FIG. 22).

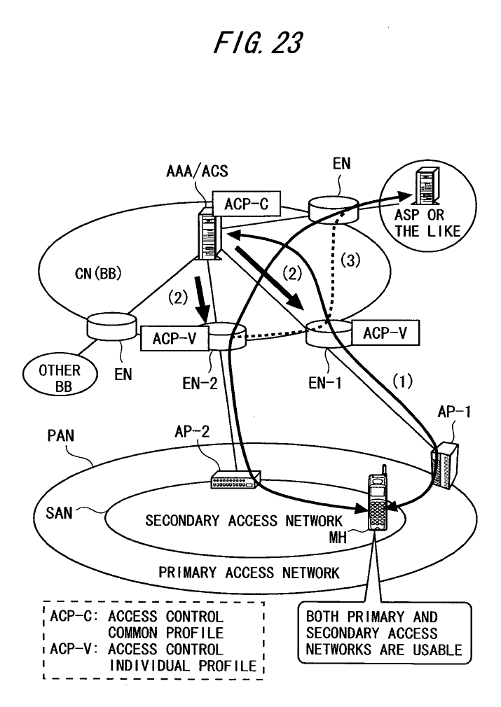

When receiving a packet addressed to the MH having undergone the access line switching, the old EN transfers the packet to the new EN ((5) in FIG. 22).

<14> Switching System 2 (Access Line Automatic Capturing Based on User's Contract Condition) (FIG. 23)

When a user (MH) that is currently performing communication using a certain access line becomes capable of using another access line defined in the ACP of the user due to predetermined circumstances (such as an improvement of a radio wave state), the network access control system detects the state of the other access line on the network side, automatically performs line capturing (communication permission), and informs the user of this situation, thereby making it possible for the user to connect to the other access line.

As an example, it is assumed that the PAN is a general mobile telephone network (such as the PDC) and the SAN is a wireless LAN network providing public wireless LAN service. Also, it is assumed that the PAN is usable in almost all of the moving range of the user while the usable range of the SAN is scattered.

As a matter of course, there is a case where the user of an MH that is capable of using both the PAN and the SAN intentionally searches for a place where the SAN is usable. In addition, it is desirable that a function can be provided with which, when a user using the PAN has moved to a place where the SAN is usable, the network side recognizes this situation and automatically performs access network switching from the PAN to the SAN.

In order to realize the function described above, in the network access control system, the AAA/ACS is made capable of detecting the existing position of the MH and has a correspondence table between PAN cell identification information (area codes) and SAN usable positions (public wireless LAN service usable positions, for instance). With this configuration, it becomes possible to recognize a situation where the existing position of the MH has moved from a region where only the PAN is usable to a region where both the PAN and the SAN are usable.

FIG. 23 shows an example of a switching system control procedure in this section of this specification. The control procedure shown in FIG. 23 will be described below.

When the existing position of the MH has moved from a region where only the PAN is usable to a region where both the PAN and the SAN are usable, the AAA/ACS informs the MH that the SAN has become usable. At this time, it is possible to use a message format shown in FIG. 33, for instance. When the user wants to use the SAN, he/she transmits an access line switching request to the AAA/ACS ((1) in FIG. 23). It is possible to issue this request using a message format shown in FIG. 34, for instance.

The AAA/ACS receives the access line switching request from the MH and recognizes that the user wishes to use the SAN. Then, the AAA/ACS carries out an SAN access authentication procedure and ACP-V generation processing and transmits a generated ACP-V to each of the ENs (EN-1 and EN-2) respectively corresponding to the PAL and the SAL ((2) in FIG. 23). At this time, the ACP-V is transmitted by means of a message shown in FIG. 33, for instance.

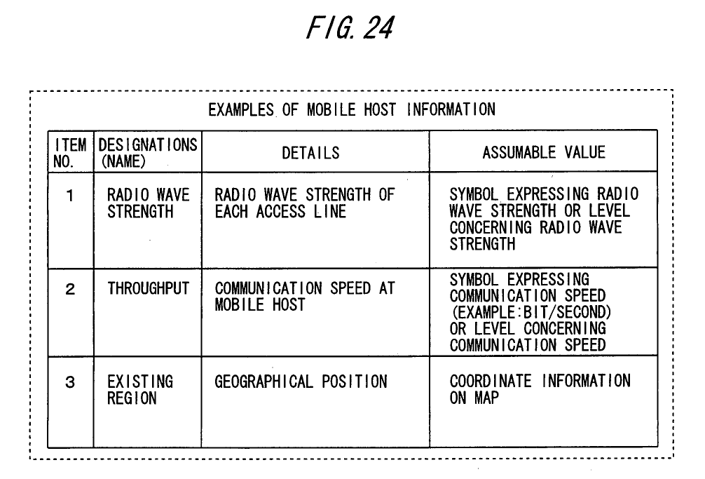

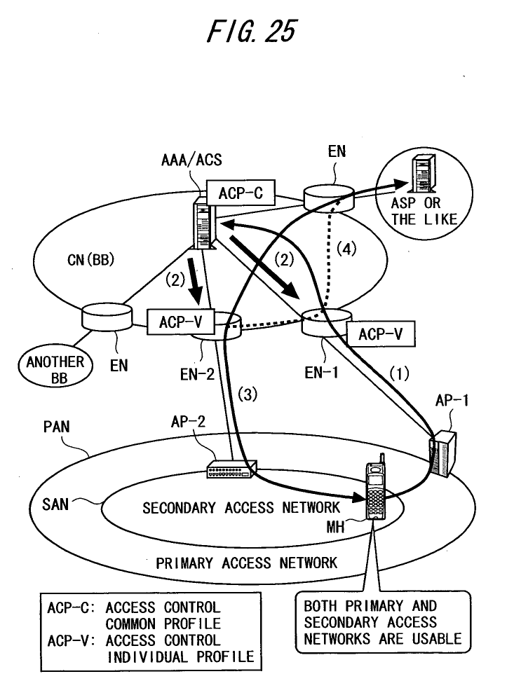

Following this, each packet addressed to the MH is interpreted at each of the EN-1 and the EN-2. Then, the EN-1 judges that the PAN is not appropriate to transfer of the packet and transfers the packet to the EN-2. On the other hand, the EN-2 judges that the SAN is appropriate to the transfer of the packet and transmits the packet addressed to the MH (including the packet transferred from the EN-1) to the MH via the SAN. Also, the MH transmits a packet addressed to a correspondent node via the SAN.

<15> Switching System 3 (Access Line Capturing Based on User Mobile Host Requirement) (FIGS. 24 and 25)

The MH on the user side has a function of feeding back its own state, such as a reception radio wave state, to the network side and the network access control system selects and captures an access line that the MH is capable of using with reference to the MH state information.

Generally, the communication speed of a wireless LAN apparatus is higher than that of a mobile communication system such as the PDC. However, even in the same type of wireless LAN system, a communication speed provided to an MH greatly varies depending on the number of MHs accommodated by the same access point that accommodates the MH or a distance of the MH from the access point. Therefore, in a communication system that has a parameter (such as a communication speed) whose varying range is large, the communication speed of the MH becomes a dominant factor of the throughput of the CN and exerts an influence on the effective speed of the application executed on the MH.

In the network access control system, whether transition should be performed or not is determined by giving consideration to the state of a transition destination access line in an inter-access-line transition operation. More specifically, when an access line that is a transition destination candidate is congested (many MHs are accommodated and its throughput is lowered, for instance), transition is not performed. Conversely, when an access line that is currently used is congested or is degraded in radio wave state, transition to a transition destination access line is performed.

In the network access control system, access line switching is performed when the MH requested it. Therefore, the MH has a function (communication parameter addition function) of adding reception quality data (communication parameter), such as a radio wave strength, of a wireless section that the MH itself grasps into a PAL authentication request message. With this function, it becomes possible to transmit the reception quality data to the AAA/ACS of the CN. On the other hand, at the time of selection and determination of a transition destination access line, the AAA/ACS makes a selection judgment by referring to the reception quality data from the MH.

FIG. 24 is a table showing examples of communication parameters (mobile host information) held in the MH. As shown in FIG. 24, as the communication parameters, it is possible to use a radio wave strength, a throughput, and an existing region (existing position).

FIG. 25 shows an example of a control procedure in this section of this specification. The control procedure shown in FIG. 25 will be described below. The MH detects that a secondary access line SAL is usable and transmits an authentication request for the secondary access line to the authentication server AAA/ACS ((1) in FIG. 25). It is possible to transmit this authentication request using a message format shown in FIG. 7 or 8, for instance.

After the authentication is completed, the AAA/ACS transmits a corresponding ACP-V ((2) in FIG. 25) to each of the EN-1 accommodating the PAL and the EN-2 accommodating the SAL. At this time, it is possible to transmit the ACP-V using a message format shown in FIG. 33, for instance.

After this, the MH is capable of performing communication using the SAL ((3) in FIG. 25).

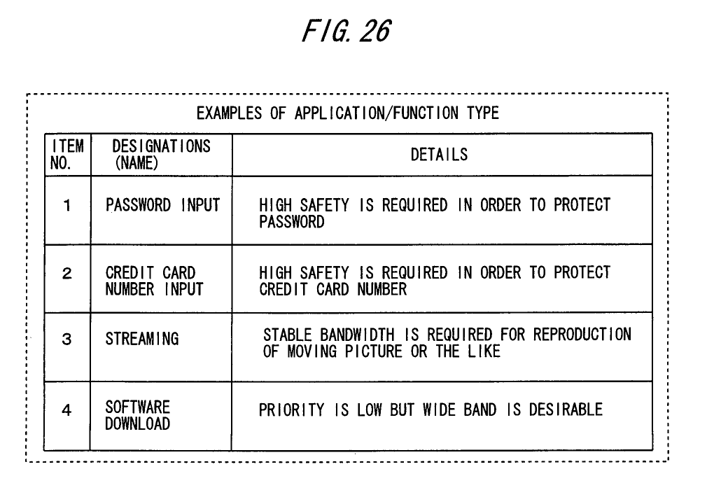

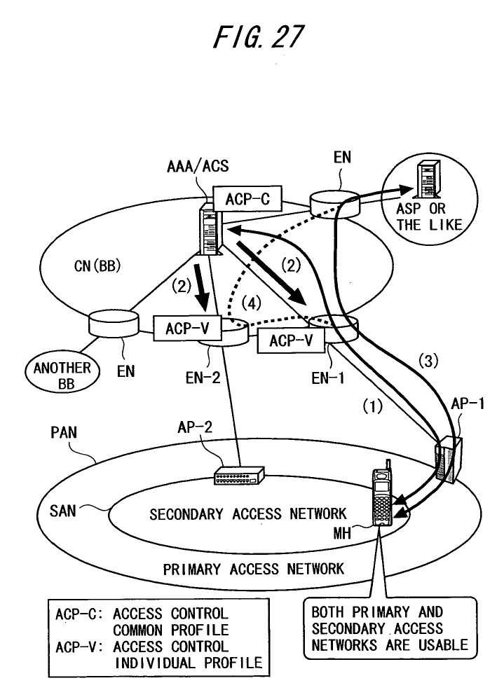

When receiving a packet addressed to the MH, the EN-1 transfers the packet to the EN-2 in accordance with the contents of the ACP-V.

<16> Switching System 4 (Access Line Automatic Switching Depending on the Type of Application Currently Used) (FIGS. 26 and 27)

There is a case where, when an MH that is currently connecting to a network using a predetermined access line newly uses a certain application, the application requires the use of a specific access line as its use condition. The network access control system detects such an application requirement and performs notification and confirmation with respect to the MH as necessary at the time of access line switching processing.

It is generally said that a mobile communication system like the PDC is inferior in communication speed to a wireless LAN but has a higher security level than the wireless LAN. Also, some of applications executed on the MH place higher importance on a security level than a communication speed. Further, there is a user's demand to perform password or credit card number transmission using a safe communication channel. Still further, there is a case where aside from the security level, a predetermined network capability (band, for instance) is required for smooth application execution.

The network access control system performs access line switching control in accordance with a request from an application so that an access line used by the MH is switched to an access line corresponding to the request from the application.

To do so, the MH has a function (application request information addition function) of adding information (application request information) showing an access line type required by an application that the MH grasps into a PAL authentication request message. With this function, it becomes possible to transmit the application request information to the AAA/ACS of the CN. On the other hand, at the time of selecting and determining a transition destination access line, the AAA/ACS makes an access line determination judgment by referring to the application request information.

FIG. 26 is a table showing examples of application types that require the use of specific access lines. As shown in FIG. 26, as examples of such application types, it is possible to cite password input, credit card number input, streaming, and software download.

FIG. 27 shows an example of a control procedure in this section of this specification. The control procedure shown in FIG. 27 will be described below. The control procedure shown in FIG. 27 is a case where an MH using the SAN attempts to use a certain application that requires the use of the PAN (the application designates communication via the PAL).

When the application designates communication via a specific access network (PAN), the MH transmits a PAL authentication request message containing application request information (containing at least the access line type of the PAL) to the AAA/ACS (access line explicit designation) ((1) in FIG. 27).

On receiving the authentication request message, the AAA/ACS performs authentication processing and transmits an ACP-V for causing only each packet corresponding to the application request to pass through the PAL to each of the EN-1 accommodating the PAL and the EN-2 accommodating the SAL ((2) in FIG. 27).

After this, each packet corresponding to the application request is transmitted and received using the PAL ((3) in FIG. 27).

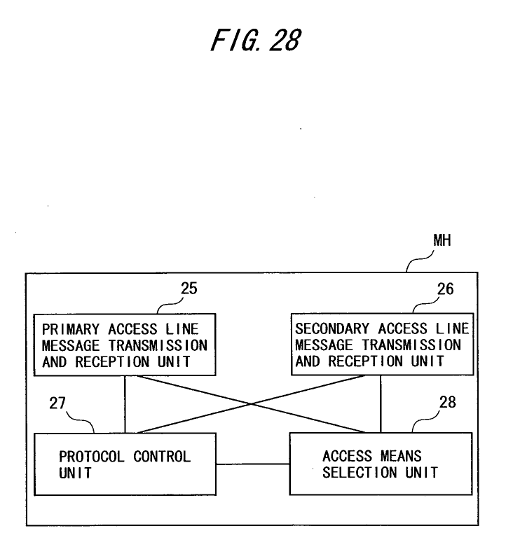

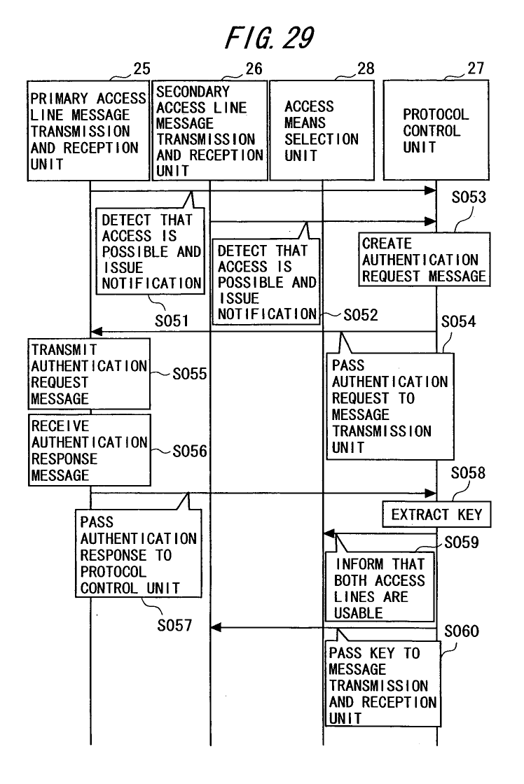

It should be noted that when a packet corresponding to the application request has arrived at the EN-2, the EN-2 transfers the packet to the EN-1 accommodating the PAL and the transferred packet is transmitted from the EN-1 to the MH via the PAL.

<17> Network Access Terminal (FIGS. 28 and 29)

Next, a terminal will be described. In the following description, as an example of the terminal, a mobile host (MH) will be described.

It is possible for the mobile host to have the authentication request message sending out function and the authentication response message processing function described in Section <3> of this specification, the communication parameter addition function described in Section <15>, and the application request information addition function described in Section <16>.

FIG. 28 shows an example of a configuration of the mobile host MH as an example of the network access terminal. It is possible to form the mobile host using a primary access line (PAL) message transmission and reception unit 25, a secondary access line (SAL) message transmission and reception unit 26, a protocol control unit 27, and an access means selection unit 28. Also, it is possible for the mobile host to transmit the authentication request messages shown in FIGS. 7 and 8 (see Section <3>).

FIG. 29 is a sequence diagram showing an example of an operation of the mobile host. As an example, a case will be described in which the MH has moved from a region where only the PAN is usable to a region where both the PAN and the SAN are usable.

1. The PAL message transmission and reception unit 25 and the SAL message transmission and reception unit 26 respectively detect that access to the PAN and the SAN is possible and inform the protocol control unit 27 of this situation (S051, S052).

2. The protocol control unit 27 creates an authentication request message for the SAL (or for the PAL and the SAL) (S053) and passes it to the PAL message transmission and reception unit 25 (S054). The PAL message transmission and reception unit 25 transmits the authentication request message to the AAA in the CN via the PAN (S055).

3. Following this, the PAL message transmission and reception unit 25 receives an authentication response message for the SAL via the PAN (S056) and passes it to the protocol control unit 27 (S057). The protocol control unit 27 extracts information (use permission information) necessary for the use of the SAL by the MH, such as a packet encryption key, from the authentication response message (S058) and passes it to the SAL message transmission and reception unit (S060). The SAL message transmission and reception unit 26 stores/manages the SAL use permission information in a predetermined storage area. Also, the protocol control unit 27 informs the access means selection unit 28 that both access means (PAL and SAL) are usable (S059).

4. After that, for instance, when an application of the MH attempts to perform packet communication, an appropriate access line is selected at the access means selection unit 28. Then, after appropriate processing, such as encryption, is performed using the held key or the like, packet transmission is performed.

Also, the MH performs the following operation when the application of the MH designates an access line to be used.

1. The protocol control unit 27 creates an authentication request message for the designated access line and transmits it from the PAL message transmission and reception unit 25 via the PAL. Through this authentication procedure, the network side detects that the access line designated by the application is to be used.

2. The PAL message transmission and reception unit 25 receives an authentication response message for the designated access line via the PAN and the protocol control unit 27 designates the access means selection unit 28 to use the designated access line. Also, use permission information, such as a key, contained in the authentication response message is extracted and is held in a message transmission and reception unit corresponding to the designated access line.

3. When the application attempts to perform communication, an appropriate access line is selected at the access means selection unit 28. Then, after appropriate processing, such as encryption, is performed using the held key or the like, transmission is performed.

According to the embodiment described above, it becomes possible to facilitate the introduction of an access network, such as a wireless LAN, as access means with respect to a core network. Also, according to the present invention, it becomes possible to achieve cooperation between access networks such as access network switching.

Further, according to the embodiment described above, it becomes possible for every user, who uses a mobile carrier and an already-existing access network, to make effective use of a network resource in cooperation with an already-existing base network service while maintaining security for a new access network at lost cost.

1. A network access control system comprising:
a reception unit receiving an authentication request message sent from a terminal that is capable of utilizing a core network by using a plurality of different types of access networks including a primary access network and a secondary access network, the authentication request message arriving at the core network via the primary access network, and containing an authentication request with respect to use of the secondary access network;
an authentication unit performing authentication processing in response to the authentication request with respect to the use of the secondary access network; and
a transmission unit transmitting an authentication response message with respect to the secondary access network, the authentication response message arriving at the terminal via the primary access network.

2. A network access control system according to claim 1, wherein the authentication request message further contains an authentication request with respect to use of the primary access network,
the authentication unit performs the authentication processing in response to the authentication request with respect to the use of each of the primary access network and said least one secondary access network, and
the transmission unit transmits the authentication response message with respect to the primary access network and the secondary access network to the terminal via the primary access network.

3. A network access control system according to claim 1, wherein when the authentication unit authenticates the use of the secondary access network, the transmission unit transmits the authentication response message containing use permission information of the secondary access network and the terminal informs the secondary access network of information for using the secondary access network.

4. A network access control system according to claim 1, further comprising:
a network control unit controlling the core network so that a communication service using the secondary access network authenticated by the authentication unit and the core network is provided for a user of the terminal in accordance with use conditions specified in a contract concluded in advance by the user of the terminal with respect to the secondary access network.

5. A network access control system according to claim 4, wherein the network control unit informs an edge node accommodating an access line of the secondary access network to be used by the terminal of control information for providing the communication service to the terminal in accordance with the use condition.

6. A network access control system according to claim 1, further comprising a charging unit performing processing relating to both a measured charge for utilization of the core network by the terminal using the primary access network and a measured charge for utilization of the core network by the terminal using the secondary access network.

7. A network access control system according to claim 6, wherein the charging unit includes:
a charging unit informing unit informing an edge node accommodating an access line of the secondary access network to be used by the terminal of a charging unit for performing the measured charge for the use of the secondary access network by the terminal; and
a calculation unit calculating a charging amount based on an amount in the charging unit relating to the terminal that the edge node measures in accordance with the charging unit.

8. A network access control system according to claim 1, wherein the authentication unit performs authentication processing of the secondary access network for a roaming user in cooperation with an authentication system of a roaming source when the reception unit receives an authentication request message containing an authentication request of the secondary access network from a terminal of the roaming user via the primary access network, and
the transmission unit transmits an authentication response message with respect to the authentication processing for the roaming user to the terminal of the roaming user via the primary access network.

9. A network access control system according to claim 8, wherein when the authentication processing for the roaming user by the authentication unit ended normally, the network control unit informs an edge node accommodating an access line of the secondary access network to be used by the terminal of the roaming user of control information for providing a communication service in accordance with a use condition of the secondary access network of the roaming user.

10. A network access control system according to claim 4, wherein the authentication request message is transmitted from the terminal when a number of access networks that the terminal is capable of using has changed through a movement of the terminal in a range where the primary access network is usable, and contains at least an authentication request of an access network that has become usable,
the network control unit judges whether access network switching should be performed for the terminal with reception of the authentication request message by the reception unit as a trigger,
the authentication unit performs authentication processing of a switching destination access network, and
the transmission unit transmits an authentication response message with respect to the switching destination access network authenticated by the authentication unit to the terminal via the primary access network.

11. A network access control system according to claim 10, wherein the network control unit judges whether the access network switching should be performed in accordance with at least one of contents of a contract concluded by the user of the terminal and a current network state.

12. A network access control system according to claim 10, wherein when a plurality of secondary access networks are selectable as the switching destination, the network control unit determines the switching destination access network based on at least one of contents of a contract concluded by the user of the terminal and a current network state.

13. A network access control system according to claim 10, wherein the transmission unit transmits the authentication response message containing use permission information with respect to the switching destination access network to the terminal in accordance with a result of the authentication of the switching destination access network by the authentication unit and the terminal informs the switching destination access network of information for use of the switching destination access network, and
the network control unit informs an edge node accommodating an access line of the switching destination secondary access network to be used by the terminal of control information for providing a communication service to the terminal in accordance with a use condition specified in a contract concluded in advance by the user of the terminal for the switching destination access network so that a communication service using the switching destination access network and the core network is provided in accordance with the use condition.

14. A network access control system according to claim 13, wherein when the communication service is provided in cooperation between a switching source edge node and a switching destination edge node, the network control unit informs each of the switching source edge node and the switching destination edge node of control information for providing a cooperation service.

15. A network access control system according to claim 13, wherein the network control unit transmits control information for providing a communication service, in which even after the access network switching, communication quality before the switching is maintained, to the edge node accommodating the switching destination access line.

16. A network access control system according to claim 13, wherein during use of the same access network by the terminal, at the time of switching of the edge node accommodating an access line of the access network used by the terminal, the network control unit transmits control information to the switching destination edge node, which is the same as control information transmitted to the switching source edge node.

17. A network access control system according to claim 13, wherein the network control unit receives traffic information from the edge node accommodating the access line used by the terminal and, when the traffic exceeds a predetermined value, requires the terminal to perform access network switching.

18. A network access control system according to claim 10, wherein the network control unit monitors a position of the terminal and, when the terminal has moved to a position at which the terminal is capable of using a predetermined secondary access network, issues a notification to the terminal.

19. A network access control system according to claim 10, wherein the reception unit receives the authentication request message containing state information of the terminal from the terminal, and
the network control unit judges whether access line switching should be performed for the terminal based on the state information.

20. A network access control system according to claim 10, wherein the reception unit receives the authentication request message containing designation information designating a switching destination access network from the terminal, and
the network control unit determines an access network designated by the designation information as the switching destination access network.

21. A network access authentication server comprising:
a reception unit receiving an authentication request message sent from a terminal that is capable of utilizing a core network by using a plurality of different types of access networks including a primary access network and a secondary access network, the authentication request message arriving at the core network via the primary access network, and containing a authentication request of use of the secondary access network;
an authentication unit performing authentication processing in response to the authentication request of the use of the secondary access network; and
a transmission unit transmitting an authentication response message with respect to the secondary access network that arrives at the terminal via the primary access network.

22. An access control server comprising:
a reception unit, at the time of authentication processing in response to an authentication request message sent from a terminal that is capable of utilizing a core network by using a plurality of different types of access networks including a primary access network and a secondary access network, the authentication request message arriving at the core network via the primary access network, and containing an authentication request of use of the secondary access network, receiving information relating to a user of the terminal and information relating to the secondary access network that is an authentication target; and
an informing unit, when the authentication processing for the secondary access network that is the authentication target by the authentication unit ended normally, informing an edge node accommodating an access line of the secondary access network to be used by the terminal of control information for providing a communication service to the terminal in accordance with a use condition specified in a contract concluded in advance by the user of the terminal for the secondary access network so that a communication service using the secondary access network and the core network is provided in accordance with a use condition.

23. A terminal that is capable of utilizing a core network by using a plurality of different types of access networks including a primary access network and a secondary access network, comprising:
an authentication request transmission unit transmitting, from the terminal itself, an authentication request message arriving at the core network via the primary access network and containing a authentication request of use of the secondary access network by the terminal itself;
an authentication response reception unit receiving an authentication response message with respect to the authentication request from the core network via the primary access network; and
a unit for utilizing the core network via the secondary access network by using use permission information with respect to the secondary access network contained in the authentication response message.

24. A network access controlling method comprising:
receiving an authentication request message sent from a terminal that is capable of utilizing a core network by using a plurality of different types of access networks including a primary access network and a secondary access network, authentication request message arriving at the core network via the primary access network, and containing a authentication request of use of the secondary access network;
performing authentication processing in response to the authentication request of the use the secondary access network; and
transmitting an authentication response message with respect to the secondary access network that arrives at the terminal via the primary access network.
